(19) United States
(12) Patent Application Publication
(10) Pub. No.: US 2004/0245272 A1
(43) Pub. Date: Dec. 9, 2004

(54) Compact dispenser with flexible door

(75) Inventors: Robert M. Fitzgerald, Norcross, GA (US); Ward P. Broom, Snellville, GA (US); Joel H. Eisler, Lawrenceville, GA (US); Kyle A. Joiner, Roswell, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Innovative Product Achievements, Inc.

(21) Appl. No.: 10/414,579

(22) Filed: Apr. 15, 2003

(51) Int. Cl. G07F 11/06

(52) U.S. Cl. 221/90

(57) ABSTRACT

A compact automated dispenser for quickly and quietly dispensing hospital linens or other items while tracking the dispenser's inventory. The dispenser preferably includes a flexible “roll-up door” that opens by rolling onto a door support, such as a roller, within the top portion of the dispenser. This makes it possible to open the door without swinging the door outwardly from the front surface of the dispenser. Alternatively, the door may be mounted on tracks to slide into the dispenser when the door is opened. A control system controls access to items within the dispenser, and closes the door automatically in response to one or more predetermined events. Such predetermined events include: (1) the passage of a pre-determined period of time; (2) a user activating a “close door” button; or (3) a sensor failing to detect the presence of a user within the proximity of the dispenser for a pre-determined period of time.

### BACKGROUND OF THE INVENTION

Hospitals commonly use linen items in examining rooms to provide a barrier between the patient and various examining room bedding items, such as examining room beds and pillows. For sanitary purposes, the linens within an examining room must be changed after a departing patient leaves the examining room and before a new patient arrives. Thus, in the context of a fast-paced emergency-room, these linens must be stored in a manner that allows employees to access the linens quickly and conveniently.

In the past, emergency room linens were typically delivered to a hospital's emergency department from a laundry facility according to a predetermined schedule and then stored on open shelves within each individual examining room. These shelves were covered with a drape to satisfy the controlling OSHA requirements for the proper storage of clean linen in a healthcare setting.

One problem associated with this method of linen distribution is that, because the linen was stored on open shelves, the various linen items were frequently stolen. To address this problem, many hospitals have begun storing linen items in locked cabinets having hinged, “swing-open” doors. In order to access the linen items from a particular storage cabinet, authorized workers typically first use a metal key to unlock the cabinet and then swing open the cabinet's door. The worker then reaches inside the cabinet and removes the needed linens. Next, the worker closes the swinging cabinet door, uses their key to re-lock the cabinet, and retrieves their key for future use. The user then either uses the linen items in the examining room (or other area) in which the cabinet is located, or takes the linen items to the proper examination room for use.

There are many disadvantages associated with using a locked, swing-door cabinet to distribute hospital linens. First, doing so requires emergency workers to locate, use, and put away a metal key each time they need to access the interior of the cabinet. Furthermore, users must open, close, and lock the cabinet's swinging doors each time they need to access a new set of linens. This can be stressful and time consuming in emergency medical situations in which any delay in having a patient treated by a doctor may affect the outcome of the patient's treatment. As a result, emergency workers commonly leave the cabinet's door open in order to avoid spending the time necessary to close the door, and to avoid unlocking and opening the door on their next visit to the cabinet. This leaves the linens within the cabinet vulnerable to theft.

A further problem with storing linens in standard swing-door cabinets is that, because the linens are locked in a solid metal cabinet, it is difficult to monitor the inventory of the cabinet. More particularly, to check the inventory of a particular cabinet, a hospital employee must physically visit and open the cabinet on a regular basis, and manually record and restock its inventory.

Accordingly, there is a need for an improved, preferably low-cost and compact, system and apparatus for maintaining hospital linens (or other items) in a secure, unattended environment that allows users to quickly retrieve needed linens while the system tracks linen inventory.

### SUMMARY OF THE INVENTION

The present invention provides an improved, low-cost, compact, fast-opening, quiet system and apparatus for maintaining hospital linens (or other items) in a secure, unattended environment that allows users to quickly retrieve needed linens while the system tracks linen inventory.

More particularly, a dispenser according to one embodiment of the invention allows users to obtain secured linen items using a standard hospital ID card. To use this embodiment of the invention, the user slides their ID card through a card reader on the dispenser and the dispenser's door automatically unlocks and opens. In one embodiment of the invention, the door is a “roll-up door” that opens by rolling onto a door support, such as a roller, within the top portion of the dispenser. This makes it possible to open the door without swinging the door outwardly from the front surface of the dispenser.

In one embodiment of the invention, the dispenser is configured to automatically close and lock after a user has removed the needed items from the dispenser. This serves to maintain the security and cleanliness of the items, while eliminating the need for hospital workers to close and lock the dispenser after each use.

In a particular embodiment of the invention, the dispenser includes an inventory display for displaying an indication of the dispenser's current inventory. The dispenser is preferably configured to be connected to a computer network, such as a cable-based or wireless LAN, so that the dispenser may continuously transmit an indication of its inventory to a central computer. This allows for the system to simultaneously monitor the inventories of many different dispensers from a central location.

In a further embodiment of the invention, the dispenser comprises: (1) a housing defining an interior portion; (2) a door for selectively restricting access to the interior portion, the door being configured so that, when the door moves from a closed to an open position, at least a first portion of the door moves within a plane defined by the first portion to create an opening through which a user may access the housing's interior portion; and (3) a control system for regulating access to the housing's interior portion by, for example, controlling the movement of the door. In one embodiment of the invention, the control system comprises a central processing unit that is configured to use identification information received from a user to determine whether to allow the user to access the interior portion.

In a particular embodiment of the invention, the door is configured so that, when the door moves from the closed to the open position, a leading end of the door moves away from a portion of the housing to create the access opening. Furthermore, in one embodiment of the invention, the flexible door is configured so that, when the door moves from an open to a closed position, the first portion of the door referred to above moves within the plane defined by the first portion. Similarly, the dispenser is preferably configured so that, when the door moves from an open to a closed position, the leading end of the door moves toward a portion of the housing to close the access opening, and thereby restricts access to the interior portion of the housing.

In one embodiment of the invention, the dispenser includes a rotatable door support. In this embodiment of the invention, the dispenser's door is mounted adjacent the rotatable door support so that, when the rotatable door support is rotated in a first direction, a portion of the door wraps around the rotatable door support. In this embodiment of the invention, the door is preferably mounted so that, when the rotatable door support is rotated in the first direction, the door moves from a closed position to an open position in which a user may access the interior portion of the housing. The door is also mounted so that, when the rotatable door support is rotated in a second direction, a portion of the door moves away from the rotatable door support. Preferably, in this embodiment of the invention, when the rotatable door support is rotated in the second direction, the door moves from an open position to a closed position and thereby restricts access to the interior portion of the housing.

In another embodiment of the invention, the dispenser comprises at least one track for guiding the movement of the door. In this embodiment of the invention, the door is configured to slide adjacent the at least one track. In a preferred embodiment of the invention, the at least one track comprises both: (1) a “door closed” portion for supporting the door when the door is in a closed position in which the door restricts access to the interior portion of the housing; and (2) a “door open” portion for supporting the door when the door is in an open position in which the door does not restrict access to the interior portion of the housing. The at least one track and the door are configured so that: (1) when the door is in the open position, a portion of the door is immediately adjacent the “door open” portion of the track; and (2) when the door is in the closed position, a portion of the door is immediately adjacent the “door closed” portion of the track.

In a particular embodiment of the invention, the dispenser comprises a spring member for maintaining the door in place on the rotatable door support.

In yet another embodiment of the invention, the dispenser is preferably configured so that when the door is in an open position, the door is positioned so that a first portion of the door is in the form of a first planar segment, and so that a second portion of the door is in the form of a second planar segment. In one embodiment of the invention, these first and second segments form an angle of about ninety degrees. In a further embodiment of the invention, the first segment is disposed adjacent a top, preferably exterior, portion of the dispenser, and the second segment is disposed adjacent a rear, preferably exterior, portion of the dispenser.

In a further embodiment of the invention, the housing defines an elongate recess that is configured for receiving the door as the door is moved from a closed to an open position, and for storing the door when the door is in the open position. This elongate recess is preferably configured to receive and store at least half of the door within the recess. In one embodiment, the recess is about the same width as at least a portion of the door. In a particular embodiment of the invention, the recess is formed so that an interior portion of the recess substantially conforms to a general exterior form of the door when the door is in the open position.

In a particular embodiment of the invention the height of the recess is substantially uniform and corresponds generally to a depth of at least a portion of the door. At least a portion of the recess is preferably gradually curved. For example, in one embodiment of the invention, the recess is generally in the form of a loose spiral.

In yet another embodiment of the invention, the dispenser includes a drive mechanism for moving the door between the open position and the closed position. In this embodiment of the invention, the dispenser preferably comprises an access system for verifying that a user is permitted to access the interior portion of the housing. Furthermore, the drive mechanism is preferably configured to move the door from the closed position to the open position in response to the access system determining that a particular user is permitted to access the interior portion of the housing. The access system preferably comprises an access card reader, and is configured for verifying an access code input by a user.

In one embodiment of the invention, the dispenser is configured so that the drive mechanism automatically moves the door from the open position to the closed position in response to a pre-determined event. In a particular embodiment of the invention, the pre-determined event is the passage of a pre-determined period of time after the door is moved into the open position. In another embodiment of the invention, the pre-determined event is the activation, by a user, of a “close-door” activation device. In a further embodiment of the invention, the pre-determined event is that a sensor has failed to detect the presence of a user for a pre-determined period of time.

In a preferred embodiment of the invention, the dispenser includes a locking device for selectively preventing a user from opening the door when the locking device is activated. This embodiment of the invention preferably also includes an access system for verifying that a user is permitted to access the interior portion of the housing. Furthermore, the locking device is configured to assume an “unlocked” configuration in response to the access system determining that a particular user is permitted to access the interior portion of the housing.

Yet another embodiment of the invention includes a flexible door that comprises: (1) a first slat defining a recess; (2) a second slat that comprises a male portion; and (3) one or more flexible elongate members for maintaining the first slat relative to the second slat so that when the flexible door is in a closed position: (1) the first slat is spaced apart from the second slat; and (2) at least a portion of the second slat's male portion is disposed within the first slat's recess. In one embodiment of the invention, the flexible door is configured so that the male portion moves out of the recess when the flexible door is moved from a closed to an open position. In another embodiment of the invention, one or more flexible members are configured to maintain the first slat relative to the second slat so that the first slat does not contact the second slat as the door is moved between an open and a closed position.

In one particular embodiment of the invention, the dispenser's flexible door comprises three or more slats, and the slats are configured so that no particular one of the slats substantially engages any other one of the slats when the door is moved between an open and a closed position.

A method of selectively distributing items according to an embodiment of the invention comprises the steps of: (1) providing a housing defining an interior portion; (2) providing a flexible door that is configured for selectively restricting access to the interior portion; (3) receiving a request from a user for permission to access the interior portion; (4) determining whether the user has permission to access the interior portion; (5) in response to determining that the user has permission to access the interior portion, moving the flexible door to allow the user to access one or more items within the interior portion; and (6) after the step of moving the flexible door to allow the user to access one or more items within the interior portion, automatically moving the door from the open position to the closed position in response to a pre-determined event, such as the pre-determined events discussed above.

A method according to a further embodiment of the invention comprises the steps of: (1) providing a housing defining an interior portion; (2) maintaining an inventory of one or more items (e.g., fabric items such as hospital linens), within the interior portion; (3) providing a flexible, roll-up door that is configured for selectively restricting access to the items; (4) receiving a request from a user for permission to access one or more of the items; (5) determining whether the user has permission to access the items; and (6) in response to determining that the user has permission to access the items, automatically moving the flexible, roll-up door to allow the user to access one or more items within the interior portion.

A method according to yet another embodiment of the invention comprises the steps of: (1) providing a secure, automated dispenser in a hospital; (2) placing one or more hospital linens within the automated dispenser; and (3) using the automated dispenser to perform the steps of: (a) receiving a request from a user for permission to access one or more of the hospital linens; (b) determining whether the user has permission to access the hospital linens; and (c) in response to determining that the user has permission to access the hospital linens, automatically moving a dispenser door to allow the user to access one or more hospital linens within the interior portion.

### BRIEF DESCRIPTION OF THE DRAWINGS

Having thus described the invention in general terms, reference will now be made to the accompanying drawings, which are not necessarily drawn to scale, and wherein:

FIG. 1A is a pictorial front view of a dispenser according to one embodiment of the present invention in which the main door is shown closed.

FIG. 1B is a pictorial front view of a dispenser according to one embodiment of the present invention in which the main door is shown open.

FIG. 2 is a pictorial front view of a dispenser's rear housing portion according to one embodiment of the invention.

FIG. 3 is a top view of the rear housing portion shown in FIG. 2.

FIG. 4 is a pictorial view of a door assembly according to one embodiment of the invention.

FIG. 5 is a series of projected views of the cross-arm end portion which is circled in FIG. 4.

FIG. 6 is an exploded view of a drive assembly according to one embodiment of the present invention.

FIG. 7A is a pictorial view a door assembly and a drive assembly according to a preferred embodiment of the invention in which the first drive subassembly is shown spaced apart from the rest of the drive assembly for illustrative purposes.

FIG. 7B is another pictorial view a door assembly and a drive assembly according to a preferred embodiment of the invention.

FIG. 8 is a top view of the dispenser taken along Section A-A shown in FIG. 1.

FIG. 9 depicts a flowchart that generally illustrates certain steps performed during the operation of a dispenser according to a particular embodiment of the current invention.

FIG. 10 is a side view of a door assembly according to a particular embodiment of the invention.

FIG. 11A is a front view of a door assembly according to another embodiment of the invention.

FIG. 11B is a top view of the door assembly of FIG. 11A.

FIG. 12 is a side view of the door assembly of FIGS. 11A and 11B.

FIG. 13 is a top, interior view of the front portion of a dispenser according to a particular embodiment of the invention.

FIG. 14A is a front view of a dispenser door according to a particular embodiment of the invention.

FIG. 14B is a top view of the dispenser door of FIG. 14A.

FIG. 14C is a side cross-sectional view of the dispenser door of FIG. 14A.

FIG. 14D is a rear view of the dispenser door of FIG. 14A.

FIG. 15 is a side view of a door assembly according to one embodiment of the invention.

FIG. 16 is a top interior view of the front right corner of a dispenser according to a preferred embodiment of the invention.

FIG. 17A is a front view of a dispenser according to one embodiment of the invention.

FIG. 17B is a top view of the dispenser of FIG. 17A.

FIG. 17C is a side view of the dispenser of FIG. 17A.

FIG. 18 is a top view of the dispenser of FIG. 17A taken along Section A-A.

FIG. 19 is a side view of the dispenser of FIG. 17A taken along Section B-B.

FIG. 20A is a top view of Detail A, which is shown in FIG. 18.

FIG. 20B is a side view of Detail B, which is shown in FIG. 18.

FIG. 21A is a side view of a dispenser according to one embodiment of the invention in which the dispenser's door is in a closed position.

FIG. 21B is a second side view of the dispenser of FIG. 21A in which the dispenser's door is in an open position.

FIG. 22 is a perspective view of a drive system according to one embodiment of the invention.

FIG. 23A is a side view of a dispenser according to another embodiment of the invention in which the dispenser's door is in a closed position.

FIG. 23B is a second side view of the dispenser of FIG. 23A in which the dispenser's door is in an open position.

FIG. 24 is a side view of a dispenser according to yet another embodiment of the invention.

FIG. 25 is a second side view of the dispenser of FIG. 24.

### DETAILED DESCRIPTION OF THE INVENTION

The present invention now will be described more fully hereinafter with reference to the accompanying drawings, in which preferred embodiments of the invention are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

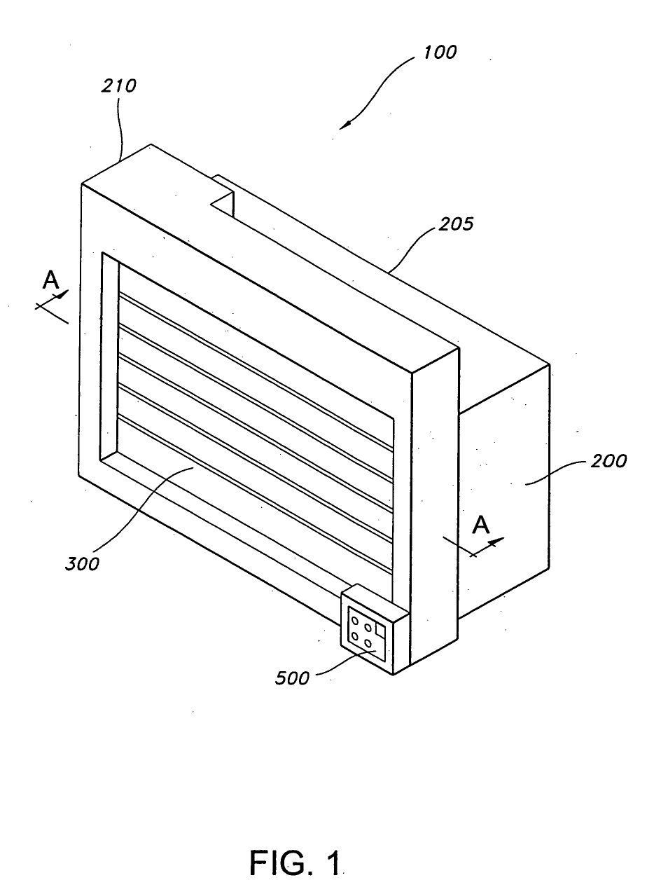

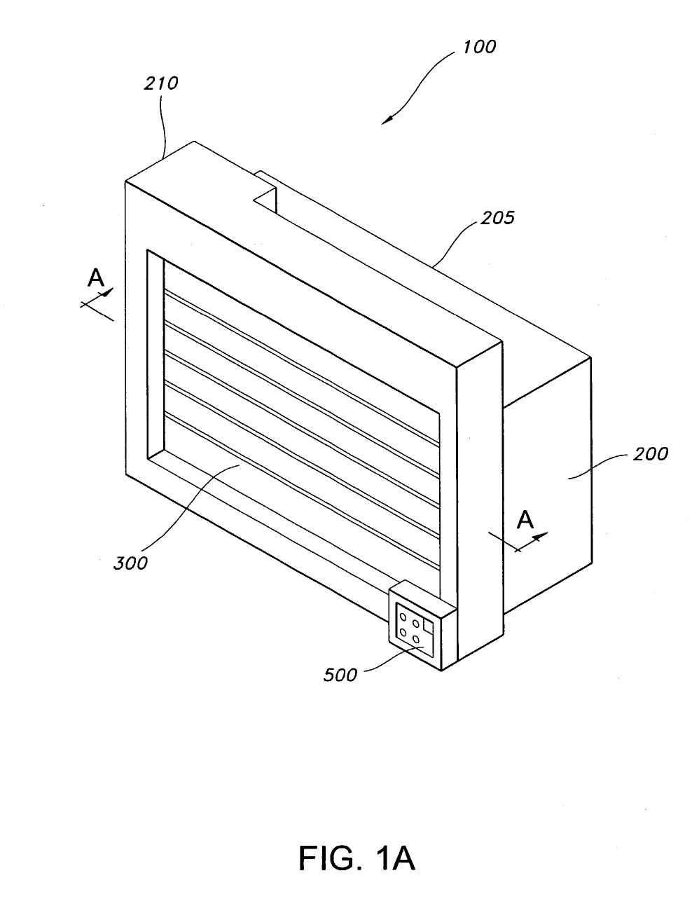

The exterior structure of a dispenser 100 according to a particular embodiment of the invention is shown in FIG. 1A. As discussed in greater detail below, the dispenser 100 preferably comprises a housing 200, a door assembly 300, a drive assembly 400, and a control panel 500.

The Housing

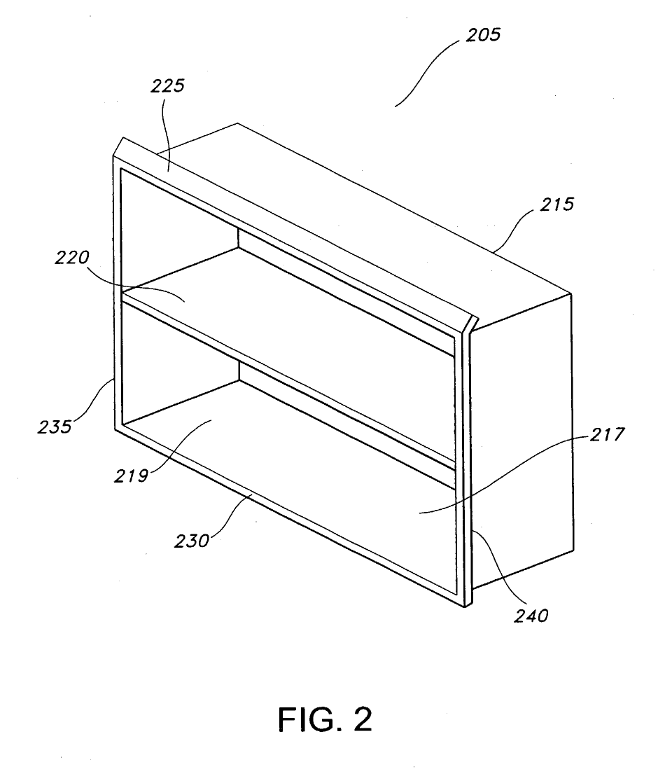

A dispenser housing 200 according to one embodiment of the invention is shown in FIGS. 1A, 1B, and 2. As may be understood from these figures, the housing preferably comprises: (1) a rear portion 205 that defines an interior portion 219 that is dimensioned to receive and store one or more items such as hospital linens; and (2) a front portion 210 that is positioned adjacent an open front face 217 of the rear portion 205.

A dispenser rear portion 205 according to one embodiment of the invention is shown in FIG. 2. As may be understood from this figure, the rear portion 205 preferably comprises: (1) a rear portion housing 215 (which is preferably in the form of a rectangular box with an open front face 217); and (2) a shelf 220 that is disposed within the rear portion housing 215 and preferably positioned so that items may be stored on or below the shelf 220. As shown in FIG. 2, the rear portion 205 of the housing 200 preferably also comprises: (1) an upper flange 225 that extends along a top edge of the rear portion's open front face 217; (2) a lower flange 230 that extends along a lower edge of the housing's open front face 217; (3) a first side flange 235 that extends along a first side edge of the housing's open front face 217; and (4) a second side flange 240 that extends along a second side edge of the housing's open front face 217.

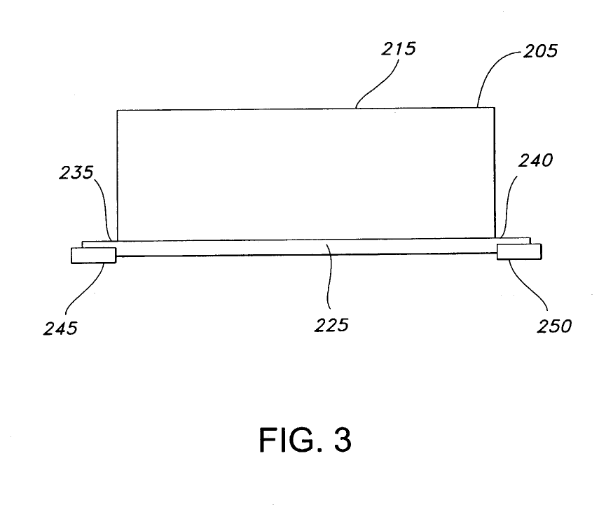

As shown in FIG. 3, which depicts a top view of the housing's rear portion 205, a first interior rub strip 245, which is preferably plastic, is disposed adjacent the first side flange 235. Similarly a second interior rub strip 250 is disposed adjacent the second side flange 240. Each interior rub strip 245, 250 preferably extends beyond the outer side edge of the side flange 235, 240 on which it is mounted. As described in greater detail below, these interior rub strips 245, 250 facilitate the movement of the dispenser's door 305 relative to the dispenser's housing 200.

The Door Assembly

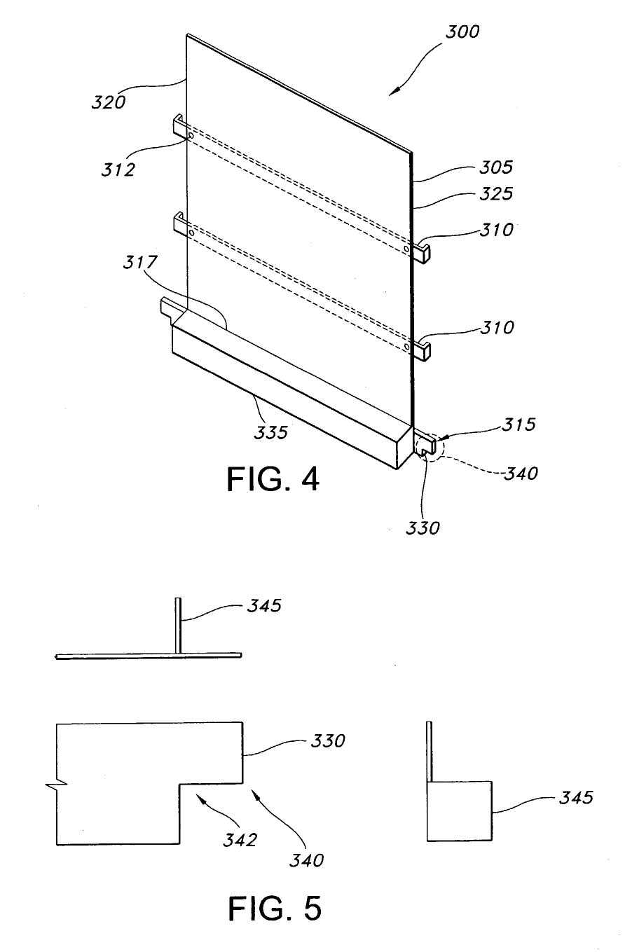

As shown in FIG. 4, in a preferred embodiment of the invention, the door assembly 300 comprises: (1) a door 305; (2) one or more support members 310; and (3) a cross-arm assembly 315. In a preferred embodiment of the invention, the door 305 preferably comprises a sheet of flexible material, such as fabric (e.g., ballistic nylon) or clear plastic. However, as will be understood by one skilled in the art, the door 305 may be made of any of a variety of other materials, such as flexible metal, interlocked pieces of a rigid material, or separate, non-interlocking slats.

In one embodiment of the invention, the door 305 comprises one or more sheets of transparent material, such as clear flexible plastic. This allows users to view the contents of the dispenser 100 without opening the dispenser's door 305. In another embodiment of the invention, the dispenser's door 305 is made of an aesthetically pleasing fabric. In a further embodiment of the invention, the door 305 is a tambour door.

In the embodiment shown in FIG. 4, the door assembly 300 comprises a ballistic nylon door 305, a series of substantially rigid support members 310 that are spaced along the length of the door 305, and a cross-arm assembly 315. The support members 310, which preferably extend between and beyond the first and second side edges 320, 325 of the door 305, provide additional support for the door assembly 300, and, as described in greater detail below, serve to prevent users from accessing the interior portion 219 of the dispenser 100 when the door 305 is closed. The support members 310 are preferably attached to the door 305 with one or more fasteners 312, such as screws or rivets. Alternatively, the support members 310 may be attached to the door 305 with an adhesive substance, such as glue.

The door assembly 300 further comprises a cross-arm assembly 315 that is preferably disposed adjacent the leading end 317 of the door 305 in a substantially horizontal position. In an embodiment of the invention shown in FIGS. 4 and 5, the cross-arm assembly 315 comprises a rear cross-arm member 330 and a front cross-arm member 335. The front cross-arm member 335, is preferably about same width as the door 305, and is preferably positioned so that the front cross-arm member 335 is adjacent the outer surface of the door 305 and so that it extends between the two side edges 320, 325 of the door 305.

The rear cross-arm member 330 is preferably slightly wider than the door 305, and is preferably positioned so that it is adjacent the inner surface of the door 305 and so that it extends between and beyond the door's two side edges 320, 325. As is described in greater detail below, the portions of the rear cross-arm member 330 that extend beyond the sides of the door 305 are preferably configured to engage a drive assembly 400 that is configured to open and close the door 305 and to interface with interior rub strips 245 and 250.

FIG. 5 shows various views of the structure of one end portion 340 of a rear cross-arm member 330 according to a preferred embodiment of the invention. As may be understood from this figure, this end portion 340 is generally in the form of a rectangle, but defines a step-like rectangular gap 342 adjacent its lower, outer edge. As discussed in greater detail below, the portion of the rear cross-arm member 330 that boarders this gap serves as a physical interface with the drive assembly 400. As may also be understood from FIG. 5, the rear cross-arm member 330 also comprises a rear tab 345 that extends outwardly from the back face of the rear cross-arm member 330. This rear tab 345 provides an interface with the interior rub strips 245 and 250.

The front and rear cross-arm members 335, 330 are preferably positioned, respectively, adjacent the front and back sides of the door's leading end 317 and are fastened together so that they exert opposing squeezing forces on the door's leading end 317. This serves to hold the cross-arm assembly 315 in place, and prevents the cross-arm assembly 315 from moving relative to the door 305.

In an alternative embodiment of the invention, the door is mounted to slide upwardly into the dispenser 100 on tracks that are adjacent the sides of the door, much like a standard garage door.

In one embodiment of the invention, one or more wires is disposed either within the door 305 or adjacent the door 305. These wires may be used, for example, to provide an interface between various parts of a security system associated with the dispenser 100. In one embodiment of the invention, a first portion of at least one of the wires is attached adjacent the leading end 317 of the door 305, and a second portion of the wire is attached to a spring-loaded spool (not shown) that is configured to support at least a portion of the wire. The spring-loaded spool is preferably configured to gradually release the wire from the spool as the door 305 is moved from an open to a closed position. Similarly, the spring loaded spool is configured to gradually take the wire up onto the spool as the door is moved from a closed to an open position. This allows a portion of the wire (such as the leading end of the wire) to move along with the leading end 317 of the door (or, alternatively, any other portion of the door) while the rest of the wire is maintained so that it does not obstruct access to the interior of the dispenser 100 or inhibit the movement of the door 305.

The Drive Assembly

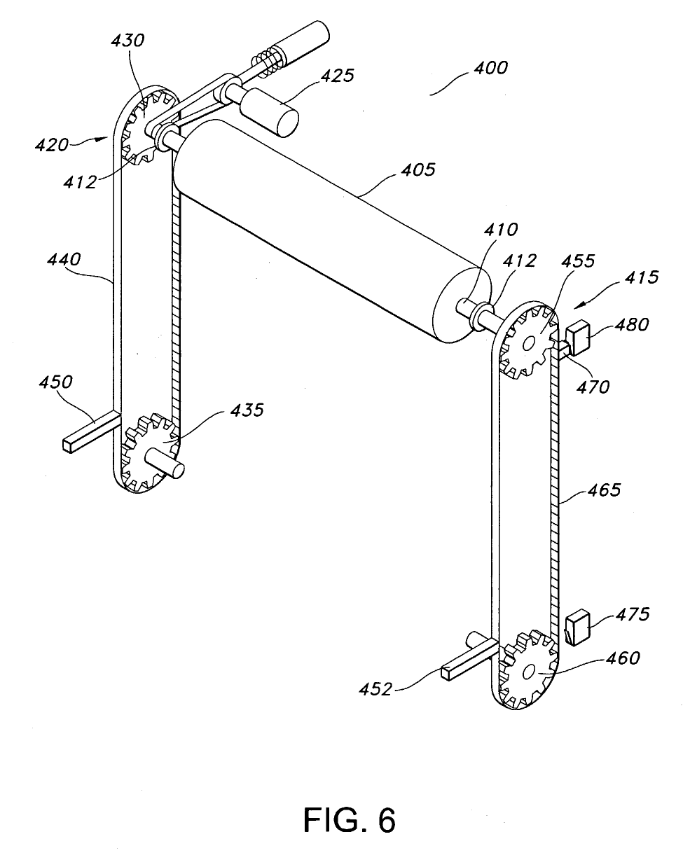

A drive assembly 400 according to one embodiment of the invention is shown in FIG. 6. In this embodiment of the invention, the drive assembly 400 is preferably configured to selectively move the door 305 between an open position, in which access to the interior 219 of the housing 200 is not restricted, and a closed position, in which access to the interior 219 of the housing 200 is blocked by the door 305. The drive assembly 400 preferably comprises a door support 405 for supporting the door 305 and for moving the door 305 between an open and a closed position. In a preferred embodiment of the invention, the door support 405 is rotatable and comprises an elongate cylindrical member.

The door support 405 is preferably mounted on a drive shaft 410 that is mounted (preferably via one or more bearings 412, in a manner well-known in the art) so that the drive shaft 410 is in a substantially fixed horizontal position adjacent the top edge of the housing's open front face 217. In a preferred embodiment of the invention, the drive shaft 410 is free to rotate about its central axis.

As may be understood from FIG. 6, one end of the door support 405 is preferably connected to a first drive subassembly 420 and the opposite end of the door support 405 is preferably connected to a second drive subassembly 415. In a preferred embodiment of the invention, the door support 405 is connected to both the second drive subassembly 415 and the first drive subassembly 420 via the drive shaft 410.

The first drive subassembly 420 preferably comprises a drive mechanism 425, such as a motor, that is in driving engagement with the door support 405 and that is configured to selectively rotate the door support 405 about its central axis both in a first direction, and in a second direction that is opposite the first direction.

The first drive subassembly 420 also preferably comprises a first rotatable support member 430, such as a sprocket or pulley, that is mounted to rotate along with the door support 405. In a preferred embodiment of the invention, the first rotatable support member 430 and the door support 405 are mounted on a common drive shaft 410.

In a preferred embodiment of the invention, which is shown generally in FIG. 6, the drive mechanism 425 is in driving engagement with the first rotatable support member 430. For example, in one embodiment of the invention, the drive mechanism 425 is connected to rotate the first support member 430 about its central axis. This, in turn, rotates the drive shaft 410 on which the door support 405 is mounted, causing the door support 405 to rotate.

The motorized drive assembly 420 also comprises a second rotatable support member 435 that is spaced apart from the first rotatable support member 430 and mounted to rotate about a central axis. In a preferred embodiment of the invention, the second rotatable support member 435 is disposed below the first rotatable support member 430 and positioned so that a plane defined by the central axis of the first rotatable support member 430 and the central axis of the second rotatable support member 435 is substantially vertical.

In a preferred embodiment of the invention, the first drive subassembly 420 comprises a first linking member 440, such as a belt or a chain, that extends around the exterior surfaces of both the first rotatable support member 430 and the second rotatable support member 435 as shown in FIG. 6. This first linking member 440 is positioned so that the rotation of the first rotatable support member 430 moves the first linking member 440 around the outer exterior surfaces of the first and second rotatable support members 430, 435 in a manner known in the art. In a preferred embodiment of the invention, the first linking member 440 is a chain and the first and second rotatable support members 430, 435 are sprockets.

The first drive subassembly 420 preferably comprises a first door locking member 450. This first door locking member 450 is configured to prevent a user from opening the door 305 when the door 305 and the first door locking member 450 are in a closed position. The first door locking member 450 preferably does this by physically obstructing the movement of at least a portion of the door assembly 300 (such as the crossarm assembly 315) from a closed to an open position.

As may be understood from FIG. 6, in one embodiment of the invention, the second drive subassembly 415 is in many ways structurally similar to the first drive subassembly 420. More particularly, in one embodiment of the invention, the second drive subassembly 415 comprises a third rotatable support member 455, such as a sprocket or pulley, that is mounted to rotate along with the door support 405. In a preferred embodiment of the invention, the third rotatable support member 455 and the door support 405 are mounted on a common drive shaft 410.

The second drive subassembly 415 also comprises a fourth rotatable support member 460 that is spaced apart from the third rotatable support member 455 and mounted to rotate about a central axis. In a preferred embodiment of the invention, the fourth rotatable support member 460 is disposed below the third rotatable support member 455 and positioned so that a plane defined by the central axis of the third rotatable support member 455 and the central axis of the fourth rotatable support member 460 is substantially vertical.

In a preferred embodiment of the invention, the second drive subassembly comprises a second linking member 465, such as a belt or a chain, that extends around the exterior surfaces of both the third and the fourth rotatable support members 455, 460 as shown in FIG. 6. This second linking member 465 is positioned so that the rotation of the third rotatable support member 455 moves the second linking member 465 around the outer exterior surfaces of the third and fourth rotatable support members 455, 460, thus causing the fourth rotatable support member 460 to rotate in a manner known in the art.

Much like the first drive subassembly 420, the second drive subassembly 415 preferably comprises a second door closing member 452 that is configured to prevent a user from opening the door 305 when then door 305 and the second door closing member 452 are in a closed position. The second door closing member 452 preferably does this by physically obstructing the movement of a portion of the door assembly 300 (such as the crossarm assembly 315) from a closed to an open position. Thus, the first and second door closing members 450, 452 serve as locking devices for the dispenser 100.

In a preferred embodiment of the invention, the second drive subassembly 415 comprises a door status sensor for sensing the current position of the door 305. In one embodiment of the invention, this door status sensor comprises a switch actuator 470 that is disposed on the outer surface of the second linking member 465 as shown in FIG. 6. This switch actuator 470 is preferably configured to activate a “door open” switch 475 when the door 305 and the second linking member 465 are in a “door open” position. Similarly, the switch actuator 470 is preferably configured to activate a “door closed” switch 480 when the door 305 and the second linking member 465 are in a “door closed” position.

As will be understood by one skilled in the art, information from the “door open” and “door closed” switches may be transmitted to the dispenser's control system, which is discussed in greater detail below. As will also be understood by one skilled in the art, any other type of sensor or other suitable device (e.g., a light sensor or pressure sensitive tape on the leading edge of the door) may be used in place of the sensors described above to detect the current position of the door 305.

The Control Panel

As shown in FIG. 1, the dispenser preferably comprises a control panel 500, which preferably includes a user interface and a display screen. In a preferred embodiment of the invention, the control panel 500 includes a touch-screen display that the user may use to enter data, such as the user's access identification number. The control panel 500 is preferably connected to a control system that is configured to control the operation of the dispenser 100. This control system is configured, for example, for selectively moving the door 305 between an open and a closed position in response to certain criteria being satisfied. In a preferred embodiment of the invention, the control system comprises a computer processor for performing logical operations, such as the determination of whether a particular user should have access to the contents of the dispenser 100.

The Interface Between the Door Assembly and the Drive Assembly

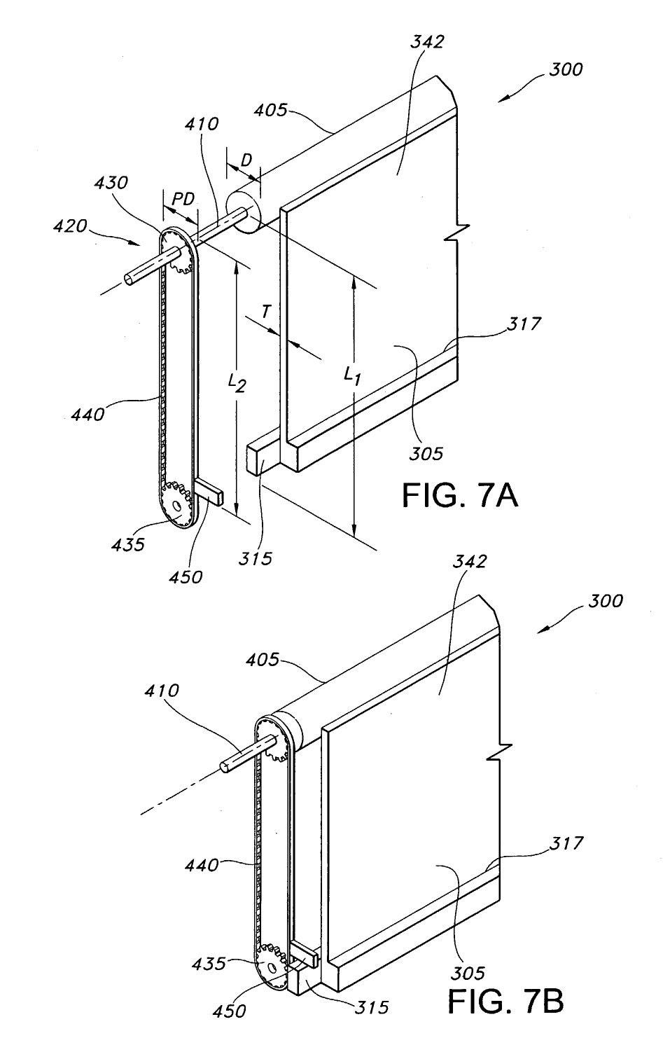

FIG. 7A shown the first drive subassembly 420 spaced apart from the door 305 for illustrative purposes. As shown in this figure, in a preferred embodiment of the invention, the interior edge 342 of the door 305 is preferably attached to the door support 405 so that, when the door 305 is initially closed and the door support 405 is rotated in a first direction, a portion of the door 305 rolls upwardly onto the door support 405. This causes the door 305 to move in the “open” direction. Similarly, the door 305 and door support 405 are preferably configured so that, when the door 305 is in the open position and the door support 405 is rotated in a second direction, a portion of the door 305 rolls downwardly off of the door support 405. This causes the door 305 to move in the “closed” direction.

As may be understood from FIG. 7B, which demonstrates the physical interaction between the first drive subassembly 420 and the door assembly 300, in a preferred embodiment of the invention, when the dispenser 100 is assembled, one end of the cross-arm assembly 315 is positioned below the first door locking member 450 and the other end of the cross-arm assembly 315 is positioned below the second door locking member 452. This allows the first and second door locking members 450, 452 to prevent the door from being manually opened by a user when the door 305 is in a fully closed and locked position.

More particularly, the drive mechanism 425 is configured to lock the first rotatable support member 430 and the drive shaft 410 in place when the drive mechanism 425 is not in operation. Also, in a preferred embodiment of the invention, the drive shaft 410 is preferably linked to the door support 405, and each of the four rotatable support members 430, 435, 455, 460 so that, when the drive shaft 410 is locked in a fixed position, the door support 405 and each of the four rotatable support members 430, 435, 455, 460 are also locked in a fixed position. As a result, in a preferred embodiment of the invention, when the door 305 is closed and the drive mechanism 425 is not active, the first and second linking members 440, 465, respectively, and the first and second door locking members 450, 452 are maintained in a fixed, locked position in which the first and second door locking members 450, 452 are immediately above the cross-arm assembly 315. This serves to prevent the door 305 from being opened manually by a user when the door 305 is in the closed position.

Another function of the door locking members 450, 452 is that they preferably travel downwardly above the cross-arm assembly 315 as the door 305 is moved from an open to a closed position. Thus, if the cross-arm assembly 315 or other part of the door 305 becomes stuck as the door 305 closes, the door locking members 450, 452 preferably will preferably engage the cross-arm assembly 315 and urge the cross-arm assembly 315 (and, thus, the door 305) into the closed position.

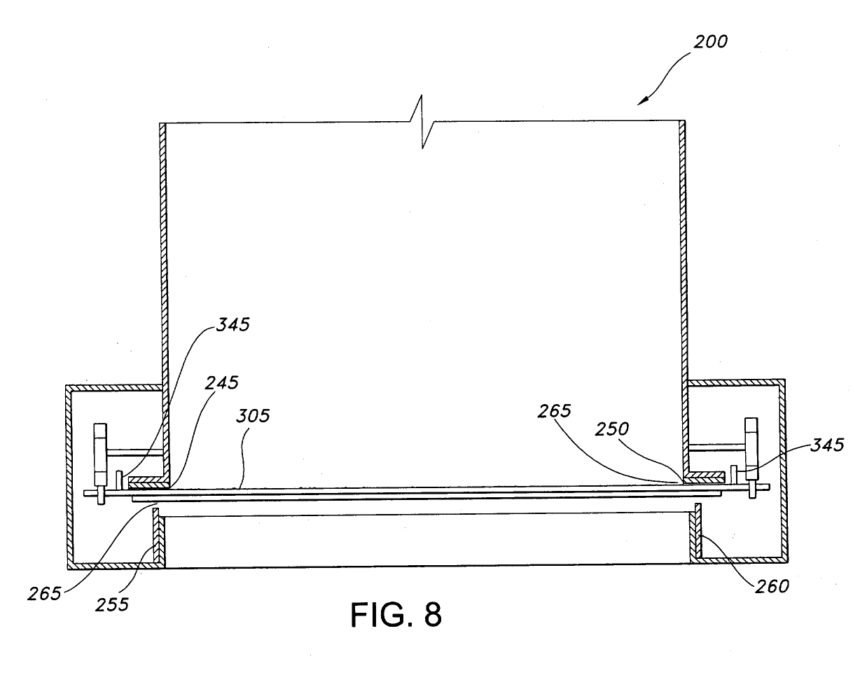

As may be understood from FIG. 8, which is a top view of the dispenser 100 taken along Section A-A shown in FIG. 1, the dispenser's housing 200 may be configured to restrict the lateral movement of the door 305. More particularly, the housing 200 may define a door-receiving passage 265 adjacent each side of the door 305 that is sufficiently wide to receive a portion of the door 305, but not sufficiently wide to receive one or more restricting tabs 345 disposed adjacent the respective side edges of the door 305. In a preferred embodiment of the invention, each door-receiving passage 265 is preferably defined by an interior rub strip 245, 250 (which is preferably made of smooth, robust plastic material) and an exterior rub strip 255, 260 (which is also preferably made of a smooth, robust plastic material). These rub strips 245, 250, 255, 260 serve to guide the door 305 as the door 305 is moved between the open and closed positions.

As may be understood from FIG. 8, the distance between the outer ends of the respective door-receiving passages 265 is preferably slightly shorter than the distance between the interior portions of the respective restricting tabs 345 and are positioned to restrict the lateral movement of the restricting tabs 345. Because the sides of the door 305 are not free to move laterally, and because the door 305 is preferably made of a non-elastic material, the restricting tabs 345 substantially prevent movement of the door 305 toward or away from the interior 219 of the housing 200. This serves to prevent unauthorized access to the interior of the dispenser 100.

It should be understood that, as the door 305 rolls up onto the door support 405, the diameter of the portion of the door 305 that is rolled around the door support 405 increases. This increases the distance between the drive shaft's central axis and the portion of the door 305 that has not yet been rolled up onto the door support 405. As a result, assuming that the drive shaft 410 is rotated at a constant rate, the speed of the door's leading end 317 increases steadily as the door 305 opens. Similarly, the speed of the door's leading end 317 decreases steadily as the door 305 closes. Accordingly, as will be understood by one skilled in the art in light of this disclosure, an important design consideration is that the dispenser 100 is preferably designed so that the first and second door locking members 450, 452 do not in physically restrict the upward motion of the crossarm assembly 315 (and therefore, the door 305) when the door 305 is being moved from a closed to an open position. More particularly, in one embodiment of the invention, the door support 405 and the various rotatable support members 430, 435, 455, 460 are selected to ensure that there is no interference between the first and second door locking members 450, 452 and the crossarm assembly 315 as the door 305 is being raised. In one embodiment of the invention, the door 305 and first and third rotatable support members 430, 455 are selected to satisfy the equation below:

$$PD \geq 1 / n {\sum }_{n = 0}^{X} ( D + 2 nt )$$

where,

PD=pitch diameter of the first and third rotatable support members 430 and 455.

n=the number of revolutions of the drive shaft 410 that is required to move the door 305 between an open and a closed position.

D=diameter of the door support 405.

t=thickness of the door 305.

(Note: it is assumed that t<<D)

x=the value of n where the sum (Σ) is equal to L₁, the distance traveled by the crossarm assembly 315 as the door 305 is moved from an open to a closed position.

It should be noted that differences between the speeds of the first and second door locking members 450, 452 and the crossarm assembly 315 may be accommodated in other ways such as by attaching the door 305 to the crossarm assembly 315 using springs or an elastic material. Using a spring or an elastic material to attach the door 305 to the crossarm assembly 315 could eliminate the limitation on the pitch diameter of the first and third rotatable support members 430, 455 described above.

Operation of a Preferred Embodiment of the Invention

To set up the dispenser 100, a maintenance worker first places items to be distributed from the dispenser 100 (e.g., hospital linens, surgical garments, food items, office supplies, or any other items) into the interior of the dispenser 100. The maintenance worker then uses the control panel 500 to indicate to the dispenser's control system which new items have been added to the dispenser's inventory. For example, in one embodiment of the invention, the maintenance worker enters an indication of the newly added inventory into the processor via a keypad on the control panel 500.

The maintenance worker then causes the dispenser's door 305 to close and lock. This may be done, for example, by activating a “close-door” activation device, as discussed in greater detail below.

In one embodiment of the invention, to retrieve items from the dispenser 100, a user first conveys user-access information (such as an access code or an employee ID number) to the dispenser's control system. In a preferred embodiment of the invention, the user does this by swiping a standard identification card through a card reader (not shown) that is electronically associated with the dispenser's control system. The card reader reads user-access information from the card in a manner well-known in the art, and then conveys the user-access information to the dispenser's access system. The access system then uses known techniques to determine whether to permit the user to access the interior of the dispenser 100. For example, the access system may search a database of valid users to determine whether an employee ID number within the user-access information is listed as a valid user. If so, the access system indicates that the user should be allowed access to the interior of the dispenser 100. If not, the access system indicates that the user should not be allowed access to the interior of the dispenser 100.

In response to the access system determining that the user should be allowed access to the interior of the dispenser 100, the control system unlocks the drive assembly 400 in a manner known in the art. The control system then activates the drive mechanism 425 which, as discussed above, rotates the first rotatable support member 430. As was also described above, this rotating action of the first rotatable support member 430 causes the second rotatable support member 435, the door support 405, the drive shaft 410, the third rotatable support member 455, and the fourth rotatable support member 460 to rotate. This, in turn, causes the first linking member 440 to rotate around the first and second rotatable support members 430, 435 and also causes the second linking member 465 to rotate around the third and fourth rotatable support members 455, 460.

The rotation of the door support 405 causes the door 305 to begin to roll up onto the door support 405. Thus, the movement of the door support 405 serves to move the door 305 from a closed to an open position. In addition, the rotation of the first and second linking members 440, 465 causes the first and second door locking members 450, 452 to move toward the door support 405.

As the second linking member 465 moves around the exterior of the third and fourth supports 455, 460, the switch actuator 470 moves from a first position, in which it activates the “door closed” switch 480, to a second position, in which it activates the “door open” switch 475. Once the switch actuator 470 reaches this second position, the “door open” switch 475 transmits a signal to the control system indicating that the door 305 is in the open position. In response to receiving this signal, the dispenser's control system stops the drive mechanism 425, which causes the door 305 to stop in the open position. Once the door 305 is open, the user can remove any needed items from the interior of the dispenser 100 by, for example, reaching into the interior 219 of the dispenser 100 and removing the items.

After the user has removed the desired items, the control system causes the drive mechanism 425 (and, thus, the drive shaft 410) to rotate in the opposite direction from which the drive mechanism 425 rotated when the door 305 was opening. This, in turn, rotates the first rotatable support member 430 which, in turn, causes the second rotatable support member 435, the door support 405, the drive shaft 410, the third rotatable support member 455, and the fourth rotatable support member 460 to rotate in the opposite direction from which they rotated when the door 305 was opening. As a result, the first linking member 440 rotates around the first and second rotatable support members 430, 435, and the second linking member 465 rotates around the third and fourth rotatable supports 455, 460. The rotation of the door support 405 causes the door 305 to begin to unwind off of the door support 405.

As the second linking member 465 moves around the exterior of the third and fourth rotatable support members 455, 460, the switch actuator 470 moves from the second position, in which it activates the “door open” switch 475, to the first position, in which it activates the “door closed” switch 480. Once the switch actuator 470 reaches this first position, the “door closed” switch 475 transmits a signal to the control system indicating at the door 305 is in the closed position. In response to receiving this signal, the control system stops the drive mechanism 425, which causes the door 305 to stop in the closed position. As noted above, because the drive mechanism 425 locks when it is in a stopped configuration, the first and second door locking members 450, 452 are held substantially rigidly in place after the door 305 reaches the closed position and the drive mechanism 425 stops. These first and second door locking members 450, 452 are preferably configured to substantially prevent the movement of the door 305 from the closed position. This serves to prevent users from accessing the interior of the dispenser 100 when the door 305 is closed.

The dispenser 100 may be configured to open and close the door 305 in response to a variety of different events. Three different embodiments of the invention, in which the door 305 opens and closes in response to different combinations of events, are described in greater detail below.

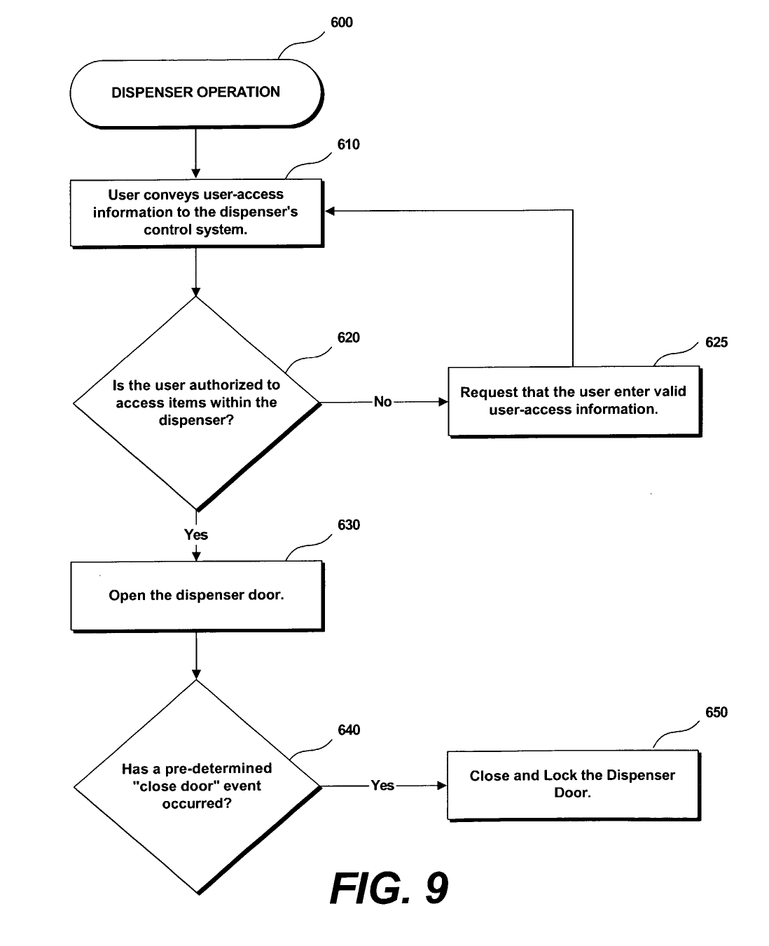

A method of using a dispenser 100 to dispense items to a user according to one embodiment of the invention is depicted in FIG. 9. More particularly, at Step 610, the user conveys user-access information to the dispenser's control system. The user preferably does this by swiping a standard identification card through a reader (e.g., a magstripe reader or a barcode reader) on the dispenser 100. Alternatively, the user may enter an access code or an employee identification number using a keypad on the dispenser's control panel 500. In another embodiment of the invention, the user may move a wireless transmitter into the proximity of the dispenser 100 that uses standard wireless communication techniques to transmit the user-access information to the dispenser 100. Alternatively, the dispenser 100 may be equipped with a device for determining whether a particular user is authorized to access items within the dispenser 100 by using known fingerprint or retinal identification techniques.

Next, at Step 620, the system determines whether the user is authorized to access items within the dispenser 100. The system preferably does this by comparing the user-access information with a list of user-access information from a data base. For example, in one embodiment of the invention, the user-access information is a user-identification number, and the system compares this user-identification number with each of a list of “valid” user-identification numbers stored within a database. If the user-identification number matches one of the “valid” user-identification numbers, the system determines that the user is authorized to access items within the dispenser 100. If not, the system determines that the user is not authorized to access items within the dispenser 100.

If the system determines, at Step 620, that the user is not authorized to access items within the dispenser 100, the system proceeds to Step 625 where it requests that the user enter valid user-access information. The system then re-executes Step 610 and continues as described above.

If the system determines, at Step 620, that the user is, indeed, authorized to access items within the dispenser 100, the system proceeds to Step 630 where it opens the dispenser door 305 as described above. The user then reaches into the dispenser 100 and removes the desired items from the interior of the dispenser 100.

In one embodiment of the invention, the door 305 of the dispenser 100 stays open until a pre-determined “close door” event occurs. This “close door event” may be one of many different types of events. For example, in one embodiment of the invention, the “close door” event is the passage of a pre-determined period of time after the door 305 is opened at Step 630. Thus, for example, the dispenser 100 may open the dispenser door 305, wait for 60 seconds, and then close the door 305 automatically after the pre-determined 60 second period has lapsed. This functionality is advantageous because it avoids requiring the user to perform any task to close the door 305. Thus, the user can simply take the items that they need and leave as soon as possible. This can be extremely beneficial in emergency medical situations in which it is crucial that items be retrieved and put to use as quickly as possible. It is also beneficial in that it assures that the door 305 is closed after each use.

In another embodiment of the invention, the “close door” event occurs when a motion sensor adjacent the dispenser 100 fails to detect motion in the proximity of the dispenser 100 for a pre-determined period of time. For example, the dispenser 100 may open the dispenser door 305, and, in response to the dispenser door 305 opening, activate a motion sensor for sensing motion in or around the dispenser 100. In response to the motion sensor failing to detect motion for 30 seconds (or any other, preferably pre-determined, period of time), the dispenser 100 closes the dispenser door 305. This system is particularly advantageous because it assures that the user has enough time to remove the items before the door 305 is closed, and also does not require the user to close the door 305 after removing the items. As will be understood by one skilled in the art, the dispenser 100 preferably includes an appropriate safety device (e.g., like the manual safety devices found commonly in elevators) for preventing the door 305 from closing when a person or object is in the door's closing path.

In yet another embodiment of the invention, the “close door” event occurs when a user activates a “close door” mechanism, such as a “close door” button or switch. This embodiment is advantageous because it allows users to control exactly when the door 305 closes, but is somewhat undesirable in that it requires the user to physically activate the “close door” mechanism to close the door 305.

In another embodiment of the invention, the “close door” event may be any of a plurality of events. For example, the dispenser 100 may be configured to close in response to a user activating a “close door” mechanism, or to close after pre-determined period of time has elapsed after the dispenser door 305 is opened. This provides the user with the optional control of specifying when the dispenser door 305 should close while assuring that the dispenser door 305 will close within a pre-determined period of time (e.g., 5 minutes).

As shown in FIG. 9, in response to determining that a “close door” event has occurred at Step 640, the system proceeds to Step 650, where it closes and locks the dispenser door 305.

In one embodiment of the invention, the user may indicate that they would like to open or close the dispenser 100 manually. For example, a user may do this by selecting an “open/close dispenser manually” key on the control panel. It may be desirable to open or close the door 305 manually, for example, if the drive assembly 400 is not functioning properly.

In this embodiment of the invention, after the user indicates that they would like to open the dispenser 100 manually, the system preferably determines whether the user should be permitted access to the interior of the dispenser 100. If not, the dispenser 100 informs the user (e.g., via a text message displayed on the control panel 500) that the user does not have permission to access the items within the dispenser 100. If the system determines that the user should be permitted access to the dispenser's interior, the dispenser 100 allows the user to manually open the dispenser's door 305. In one embodiment of the invention, the dispenser 100 accomplishes this by disengaging the dispenser's drive mechanism 425 from the rest of the dispenser's drive assembly 400.

Similarly, if the user indicates that they would like to close the dispenser 100 manually, the dispenser 100 allows the user to manually close the dispenser's door 305 by, for example, disengaging the dispenser's drive mechanism 425 from the rest of the dispenser's drive assembly 400.

In a preferred embodiment of the invention, the dispenser 100 includes inventory maintenance functionality. In such an embodiment, the dispenser 100 is preferably configured to maintain a current list of items that are within the dispenser 305, and to update the list as items are removed from the dispenser 305.

To use one embodiment of the invention that includes inventory maintenance functionality, after the system verifies that the user should be allowed access to the interior of the dispenser 100, the dispenser 100 displays (for example, on a display screen) a list of items within the dispenser 100. The user then indicates (e.g., using the control panel 500) which of the items the user intends to remove from the dispenser 100. In response to the user indicating which items the user intends to remove from the dispenser 100, the dispenser 100 opens the dispenser door 305 to allow the user to access the specified items. In addition, the dispenser 100 updates its current inventory information to reflect the fact that the specified items are no longer within the dispenser 100.

In a preferred embodiment of the invention, the dispenser 100 is associated with one or more computers via a network (e.g., a standard or wireless computer network), and is configured to provide current inventory information to a remote computer. For example, in one embodiment of the invention, the dispenser 100 is connected to a local area network, and is configured to transmit current inventory information to a central computer (e.g., within a central supply room) upon receiving an inventory information request from the central computer. This allows maintenance workers to check the current inventory status of the dispenser 100 without actually physically examining the dispenser 100.

In one embodiment of the invention, the dispenser 100 is configured to produce a low-inventory indicator when the dispenser's inventory falls below a certain, predetermined level. This low inventory indicator may be, for example, a color-coded message that is displayed on the dispenser's display screen, an audible low-inventory warning, or a message that is transmitted to a central computer (or to a mobile electronic device, such as a pager or personal digital assistant) indicating that the dispenser 100 needs to be restocked.

In a further embodiment of the invention, the dispenser 100 is configured to display descriptive names for particular groupings of linen items. For example, the system may use the term “new patient” as a shorthand term to describe a group of linen items that comprises all of the linen items needed to prepare an examining room for a new patient. Thus, when a user needs to set up a room for a new patient, the user can simply press a “new patient” inventory button to indicate that they intend to remove from the dispenser 100 all of the items needed to prepare an examining room. This feature is useful because it allows users to make inventory entries for multiple items by performing a simple task, such as pressing a single button.

Alternative Embodiments of the Invention

As will be understood by one skilled in the art in view of this disclosure, many alternative embodiments of the invention are possible. Several aspects of a few selected alternative embodiments of the invention are discussed below.

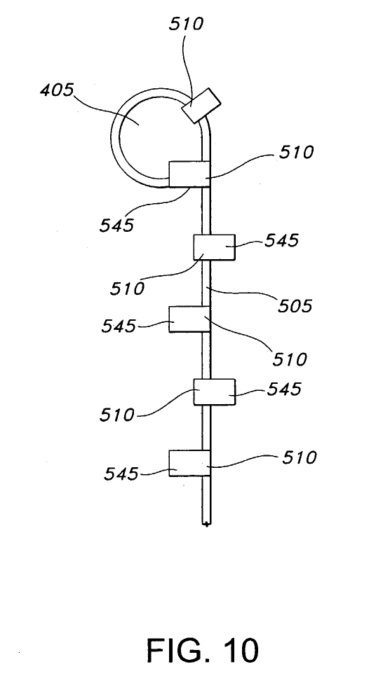

A schematic side view of a door 505 and door support 405 according to an alternative embodiment of the invention are shown in FIG. 10. As may be understood from this figure, the various restricting tabs 545 are positioned, in an alternating fashion, so that every other restricting tab 545 extends outwardly from the front face of the door 505. All of the remaining restricting tabs 545 extend outwardly from the rear face of the door 505. This increases the number of support members 510 that can be wound onto the door support 405.

In another alternative embodiment of the invention, the rotatable support members 430, 435, 455, 460, the first and second linking members 440, 465, and the first and second door locking members 450, 452 are omitted. In this embodiment, the drive mechanism is connected to rotate the drive shaft 410 which, in turn, moves the door 305 between an open and a closed position.

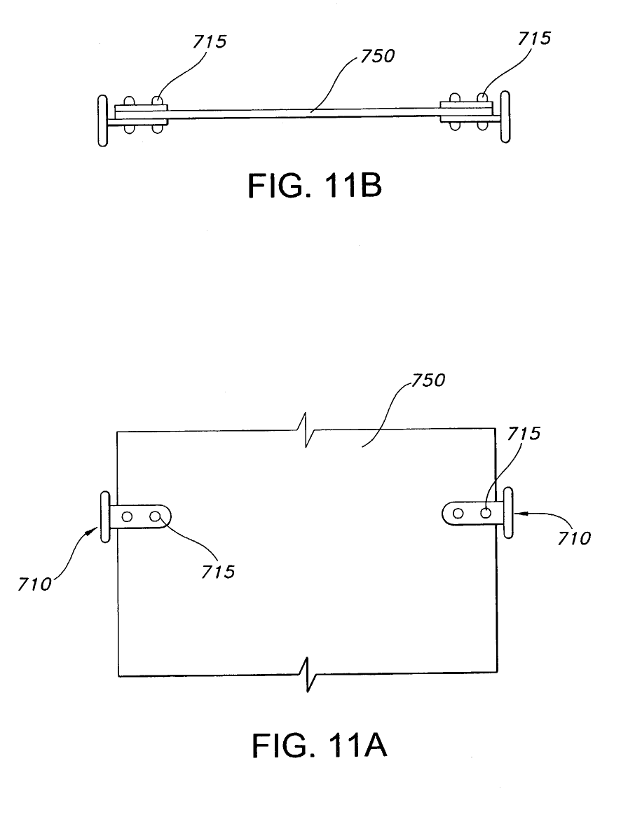

In yet another alternative embodiment of the invention, which is shown in FIGS. 11A and 11B, the door 750 does not include support members 310, but rather includes t-shaped tabs 710 adjacent the edges of the door 750. As may be understood from this figure, the t-shaped tabs 710 are preferably fastened to the door 750 using fasteners, such as rivets 715.

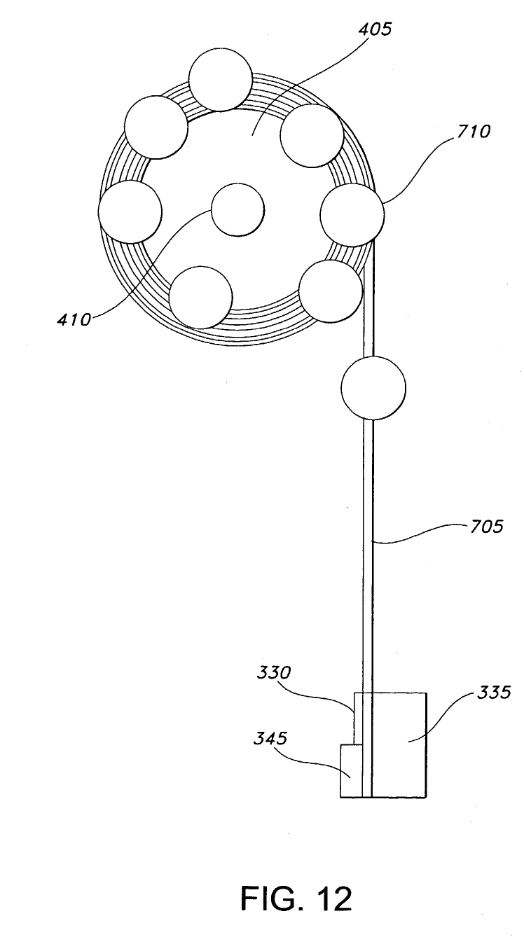

FIG. 12 depicts a side view of the alternative embodiment of the invention discussed above in regard to FIGS. 11A and 11B. These figures shows how the door 705 and t-shaped tabs 710 roll onto the door support 405.

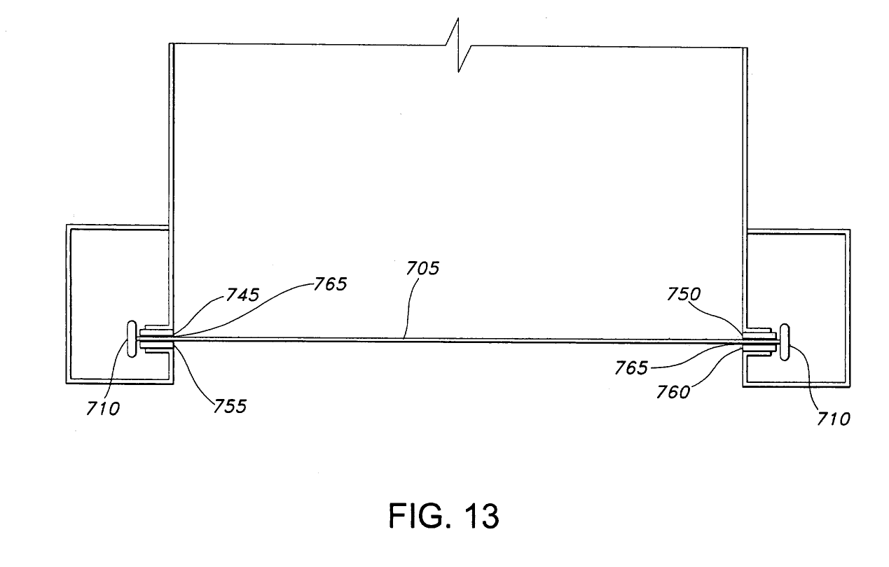

FIG. 13 shows an embodiment of the invention that includes t-shaped tabs 710 as described above, and that also includes guide slots 765 on either side of the door 705 for receiving and guiding the t-shaped tabs 710 as the door 705 moves between an open and a closed position. In this embodiment of the invention, each guide slot 765 is defined, at least in part, by an interior rub strip 745, 750 and an exterior rub strip 755, 760.

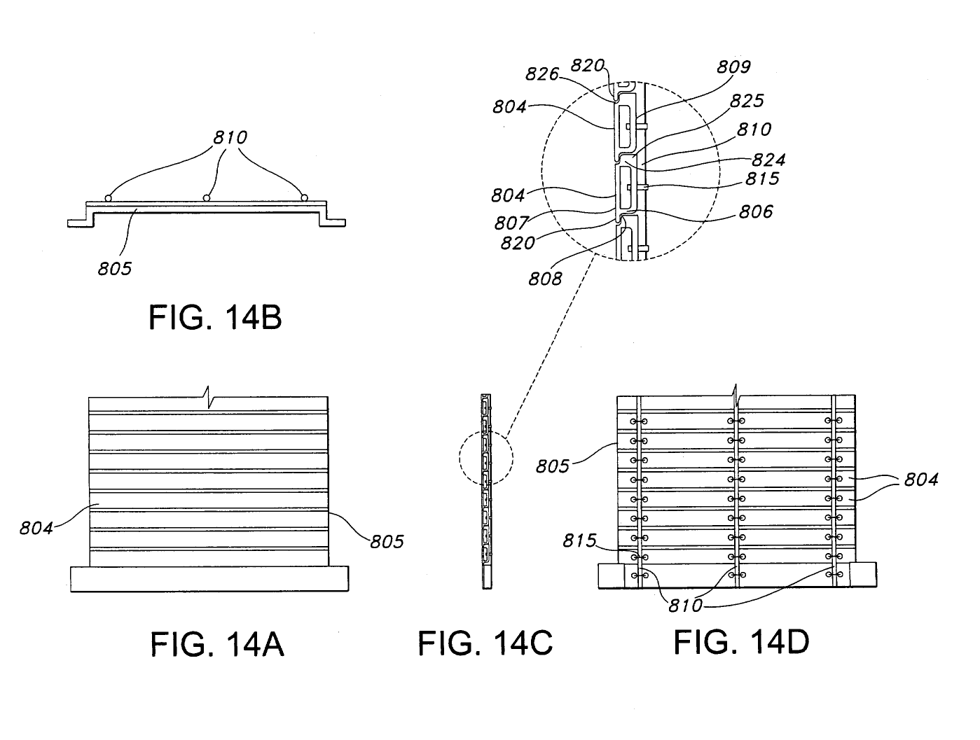

In one alternative embodiment of the invention shown in FIGS. 14A-14D, the door 805 comprises a series of horizontal, substantially parallel slats 804 that are preferably fastened together so that the door 805 may flex along gaps defined by the co-facing sides of each adjacent pair of slats 804. FIGS. 14A-14D visually depict the manner in which the slats 804 are connected together to form the door 805 in this embodiment of the invention.

As may be understood from FIGS. 14A-14D, in this embodiment of the invention, the slats 804 are preferably connected together by two or more flexible elongate members 810, such as ropes or cables. The flexible elongate members 810 are preferably attached to each slat 804 using an appropriate fastener. In a preferred embodiment of the invention, twist tabs 815 are used to attach the flexible elongate members 810 to the slats 804 as shown in FIGS. 14C and 14D. The flexible elongate members 810 serve to hold the slats 804 in place and also serve to provide a cushioned surface for the slats 804 as they roll onto the door support 405. If the door support 405 rotates more than one revolution, the flexible elongate members 810 (which are preferably made of a soft material) serve as a soft buffer between the various layers of slats 804 supported by the door support 405. This serves to reduce the noise that would otherwise occur as a result of the various slats 804 engaging each other as they are rolled onto the door support 405.

As shown in FIG. 14C, in one embodiment of the invention, each slat 804 includes a front lip 820 that extends along, and outwardly from, a first horizontal edge 806 (e.g., the bottom edge) of the slat 804 adjacent the slat's front face 807. In a particular embodiment, the front lip 820 and the first horizontal edge 806 form a first recess 808.

Each slat 804 also includes a rear lip 825 that extends along, and outwardly from, a second horizontal edge 824 (e.g., the top edge) of the slat 804 adjacent the slat's rear face 809. In a particular embodiment, the rear lip 825 and the second horizontal edge 824 form a second recess 826. Also, in one embodiment of the invention, the rear lip 825 is shorter than the front lip 820. This allows each particular slat 804 to easily rotate relative to its adjacent slats 804 as the door 805 is rolled up on the door support 405. The rear lip 825 is preferably wider than the front lip 820.

When the door 805 is assembled, the slats 804 are preferably installed so that the rear lip 825 of each particular slat 804 (that is not an end slat) is disposed within the slat's first recess 808. This feature makes the door 805 resistant to tampering, and also prevents unauthorized individuals from determining what is inside the dispenser 100 by looking through the gaps between the door's adjacent slats 804.

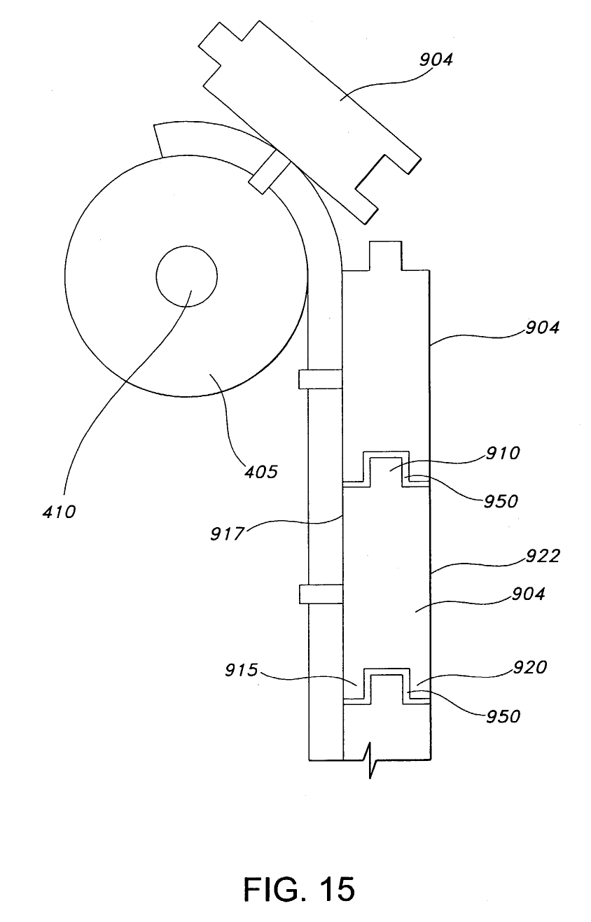

In an alternative embodiment of the invention, which is shown in FIG. 15, each slat 904 includes a “male” center lip 910 that extends along, and outwardly from, a center portion of a first horizontal edge of each slat 904. Furthermore, each slat 904 includes a rear lip 915 that extends along, and outwardly from, a second horizontal edge of the slat 904 adjacent the slat's rear face 917, and a front lip 920 that extends along, and outwardly from, a second horizontal edge of each slat 904 adjacent the slat's front face 922. The front and rear lips 915, 920 cooperate to define a gap 950 between the front and rear lips 915, 920 that is dimensioned to receive the center lip 910 from an adjacent slat 904. Thus, together, the front and rear lips 915, 920 act as a female member that is configured to receive a mating “male” center lip 910 from an adjacent slat 904.

When the door 905 is assembled, the slats 904 are preferably installed so that the center lip 910 of each particular slat 904 (that is not the innermost end slat) is positioned between the front lip 920 and the rear lip 920 of another slat 904 that is adjacent the second horizontal edge of that particular slat 904. This feature makes the flexible door 400 resistant to tampering, and also prevents unauthorized individuals from determining what is inside the dispenser 100 by looking through the gaps between the door's adjacent slats 904.

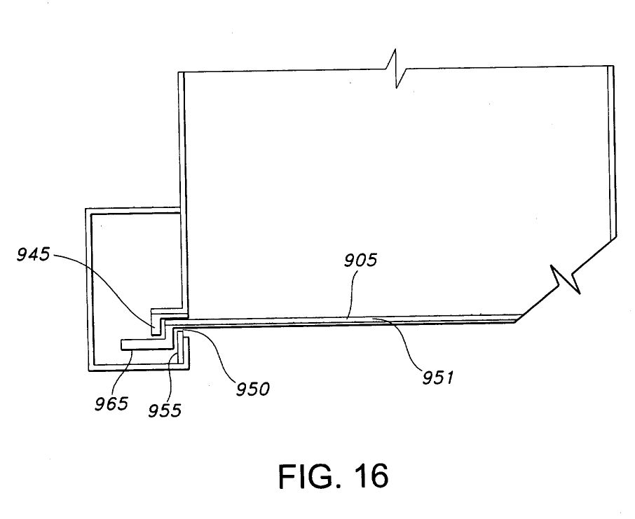

As may be understood from FIG. 16, in one embodiment of the invention, the ends of the horizontal slats 951 and the cross-arm assembly are configured to slide in a gap 950 defined by interior and exterior rub strips 945, 955 such as those discussed above. The rub strips 945, 955 serve to prevent the slats 951 and cross-arm assembly from moving laterally, and from being pulled away from the dispenser 100.

This embodiment of the invention preferably includes an additional movement restricting member 965 that extends outwardly from the front face of the door 905 within the gap 950. This restricting member 965 serves to further prevent unauthorized individuals from breaking into the dispenser 100 by kicking or pushing the front of the door 100.

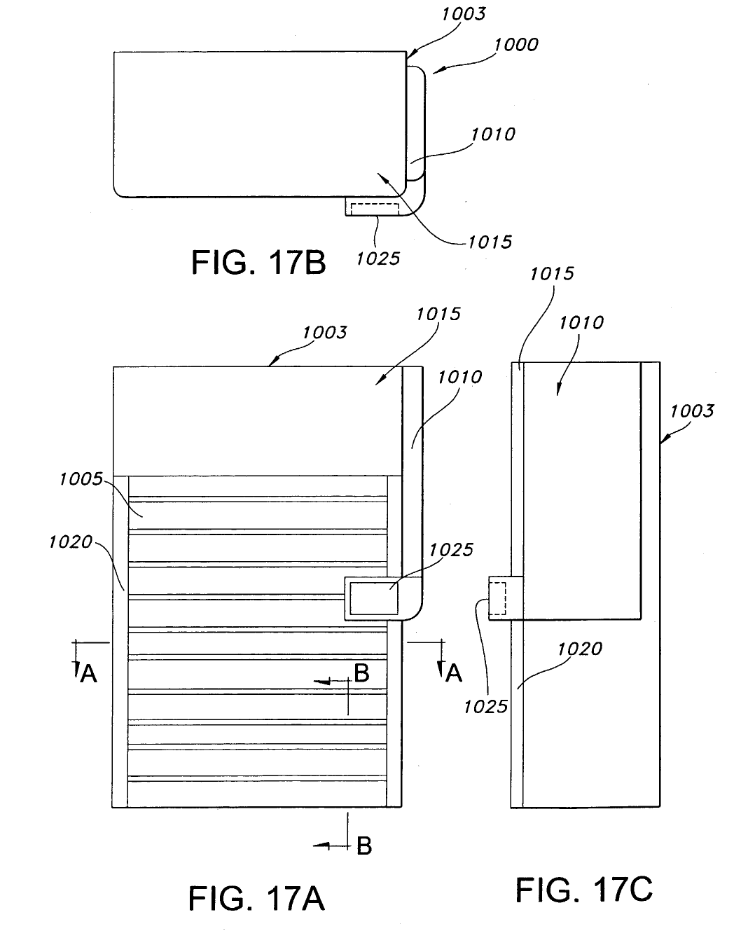

FIGS. 17A-17C depict various views of a dispenser 1000 according to one embodiment of the invention. As may be understood from these figures, the dispenser 1000 comprises a housing 1003, which comprises a side cover 1010, a top cover 1015, and an end portion 1020. Like the various embodiments of the dispenser discussed above, the dispenser's housing 1003 defines a recess (not shown) for storing items to be dispensed from the dispenser 1000. The dispenser 1000 also comprises a door 1005 (which may be configured like the tambour door discussed above) for selectively restricting access to items stored within the housing's recess.

As may be understood from FIGS. 17A-17C, the dispenser 1000 further comprises a control panel 1025 that is preferably configured so that it may be positioned adjacent, and preferably overlapping, a front surface of the door 1005 when the door is in a closed position. In one embodiment of the invention, the control panel 1025 is configured so that at least a third, and preferably at least half or at least three quarters of the control panel 1025 is configured so that it may be positioned so that it overlaps a front surface of the door 1005 when the door is in a closed position. In one embodiment of the invention, the control panel 1025 is substantially fixedly mounted so that it overlaps a front surface of the door 1005 when the door is in a closed position.

In another embodiment of the invention, the control panel 1025 is mounted to rotate between: (1) a first position, in which the control panel 1025 is overlapping a front surface of the door 1005; and (2) a second position, in which the control panel 1025 is not overlapping a front surface of the door 1005. In one embodiment of the invention, the control panel 1025 is mounted to at least partially obstruct the front opening of the recess defined by the dispenser's housing 1003.

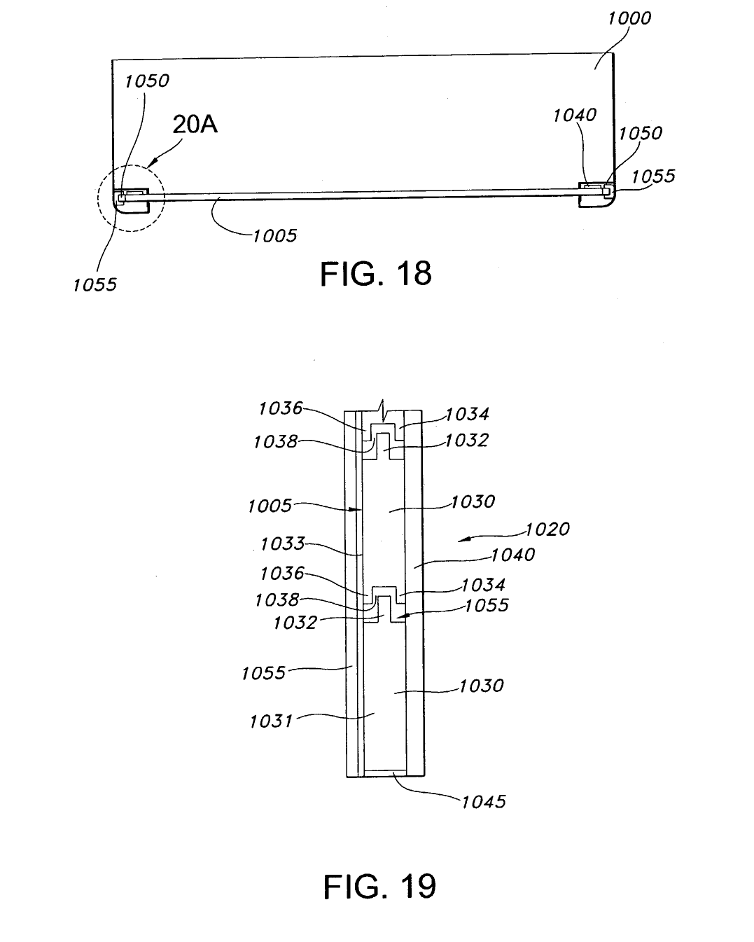

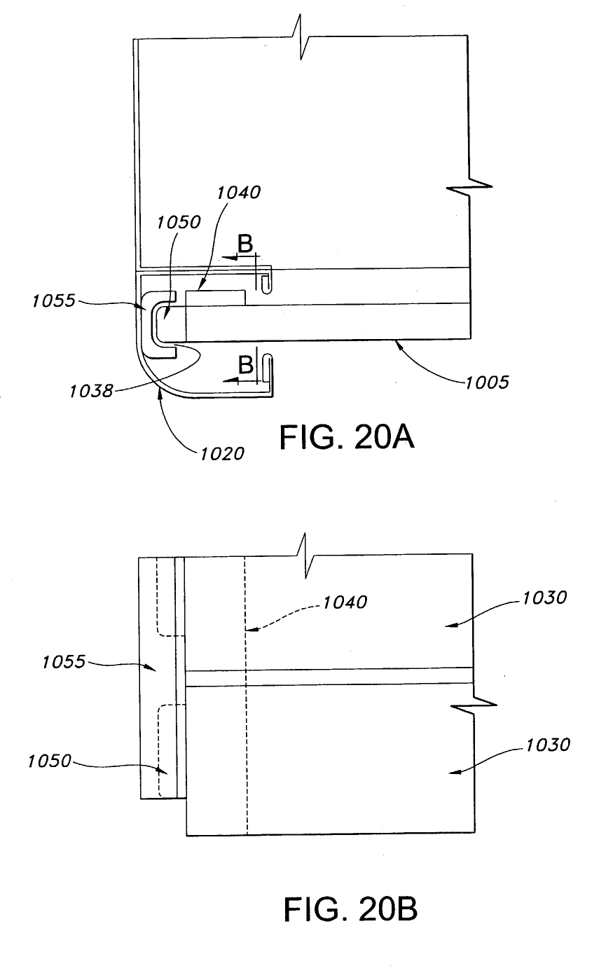

FIGS. 18, 20A, and 20B depict an end structure of a door 1005 and the corresponding housing interface according to one embodiment of the invention. As may be understood from these figures, one or more of the end portions of one or more of the door's slats 1030 comprises a plastic bumper 1050 that is configured to glide within a recess 1038 defined by a guide strip 1055 disposed within an interior portion of the dispenser's housing 1003. As may be understood from FIG. 20A, the guide strip 1055 is preferably an elongate, substantially vertical, U-shaped member that defines a recess 1038. This recess 1038 is preferably dimensioned to receive at least a portion of a plastic bumper 1050. In a preferred embodiment of the invention, at least a portion of the guide strip 1055 is configured to substantially conform to an exterior surface of a plastic bumper 1050 so that there is only a small gap (e.g., a gap that is less than one quarter inch wide) between at least a portion of the plastic bumper 1050 and the interior portion of the guide strip 1055.

As may be understood from FIGS. 20A and 20B, a flexible elongate member 1040 is preferably disposed adjacent a side end portion (and preferably both side end portions) of each of the various slats 1030. Also, as may be understood from FIG. 18, in one embodiment of the invention, both side ends of each slat 1030 preferably include a plastic bumper 1050 that is in essentially the configuration shown in FIGS. 20A and 20B. Similarly, as shown in FIG. 18, guide strips 1055 are preferably provided adjacent both ends of the slats 1030 for guiding the plastic bumpers 1050 as discussed above.

FIG. 19 shows a side view of the interior of the door 1005 taken along Section B-B of FIG. 17A. In one embodiment of the invention, which is shown in FIG. 19, the slats 1030 are in essentially the same general physical form as the slats 904 described above in regard to FIG. 15. More particularly, each slat 1030 includes a “male” center lip 1032 that preferably extends along, and outwardly from, a center portion of a first horizontal edge of each slat 1030. Furthermore, each slat 1030 includes a rear lip 1034 that extends along, and outwardly from, a second horizontal edge of the slat 1030 adjacent the slat's rear face, and a front lip 1036 that extends along, and outwardly from, a second horizontal edge of each slat 1030 adjacent the slat's front face. The front and rear lips 1036, 1034 cooperate to define a recess 1038 between the front and rear lips 1036, 1034 that is dimensioned to receive the center lip 1032 from an adjacent slat 1030. Thus, together, the front and rear lips 1036, 1034 act as a female member that is configured to receive a mating “male” center lip 1032 from an adjacent slat 1030.

When the door 1005 is assembled, the slats 1030 are preferably installed so that the center lip 1032 of each particular slat 1030 (that is not the innermost end slat) is positioned between the front lip 1036 and the rear lip 1034 of the slat 1030 that is adjacent the second horizontal edge of that particular slat 1030. This feature makes the door 1005 resistant to tampering, and also prevents unauthorized individuals from determining what is inside the dispenser 1000 by looking through the gaps between the door's adjacent slats 1030.

In one embodiment of the invention, the various slats 1030 (or any other embodiment of the slats) are attached so that they are maintained in a spaced-apart relationship, and so that the various slats 1030 do not engage other slats 1030 as the door 1005 is opened or closed. This essentially eliminates any frictional contact between the slats 1030, which reduces the noise associated with opening and closing the door 1005 and also reduces the frictional wear on the various slats 1030.

For example, in the embodiment of the invention, at least two of the slats 1030 (a first slat 1031 and a second slat 1033) are attached to at least one flexible elongate member 1040 (preferably a substantially non-compressible strip such as a plastic strip, a timing belt, a v-belt, or a fabric such as Kevlar) that is configured to maintain the slats 1030 in a spaced apart relationship in which the center lip 1032 of the first slat 1031 is positioned within the recess 1038 defined by the rear and front lips 1034, 1036 of the second slat 1033, but so that no substantial (and preferably no) contact is made between the first and second slats 1031, 1033. For example, as shown in FIG. 19, the first and second slats 1031, 1033 are preferably positioned so that a gap is constantly maintained between the first slat 1031 and the second slat 1033.

In one embodiment of the invention, all of the door's various slats 1030 are configured in this manner so that no particular slat 1030 substantially engages any other slat 1030 when the door 1005 is opened or closed. In one embodiment of the invention, the door's various slats 1030 are configured so that no particular slat 1030 engages any other slat 1030 when the door 1005 is opened or closed. As noted above, this allows for quiet operation of the door 1005.

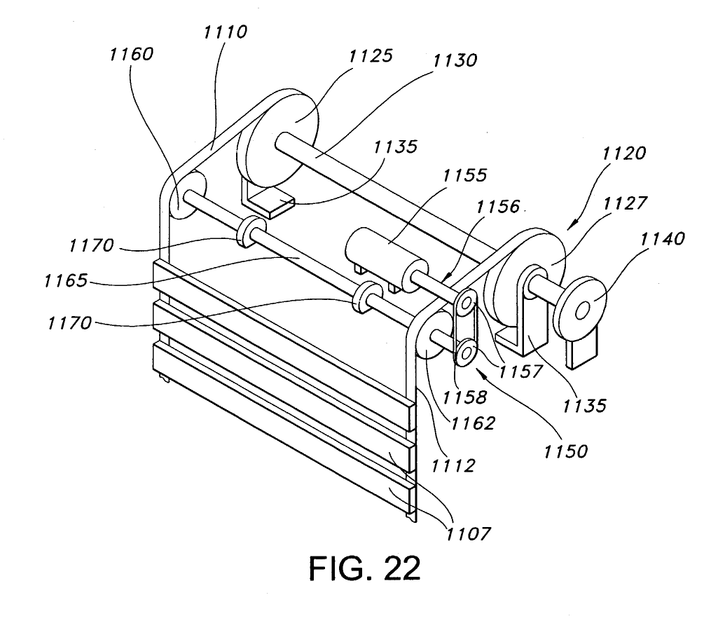

It should be understood that this configuration (in which two or more of the slats are configured to not substantially engage each other when the door is opened and/or closed) may be applied to embodiments of the door having different types of slats than those discussed in reference to FIG. 19. For example, this configuration may be applied in an embodiment of the door 305 having slats such as those described in reference to FIGS. 14A-14D. Similarly, this configuration may be applied in an embodiment of a door 305 having slats that are spaced apart from one another to form a gap, but that are not configured so that, when the door 305 is in a closed position, a portion of each slat is disposed within a recess defined by an adjoining slat. Such a configuration is depicted generally in FIG. 22.

As may be understood from FIG. 19, in one embodiment of the invention, the leading slat 1031 (e.g., the slat 1030 that is adjacent the bottom of the dispenser 1000 when the door 1005 is closed) preferably comprises a safety stop 1045 adjacent a leading edge of the leading slat 1031 that is configured to sense the presence of any obstruction and send a signal to the dispenser's control mechanism to stop the door 305 from closing if such an obstruction is detected. This serves to prevent the door 305 from inadvertently closing on a user.

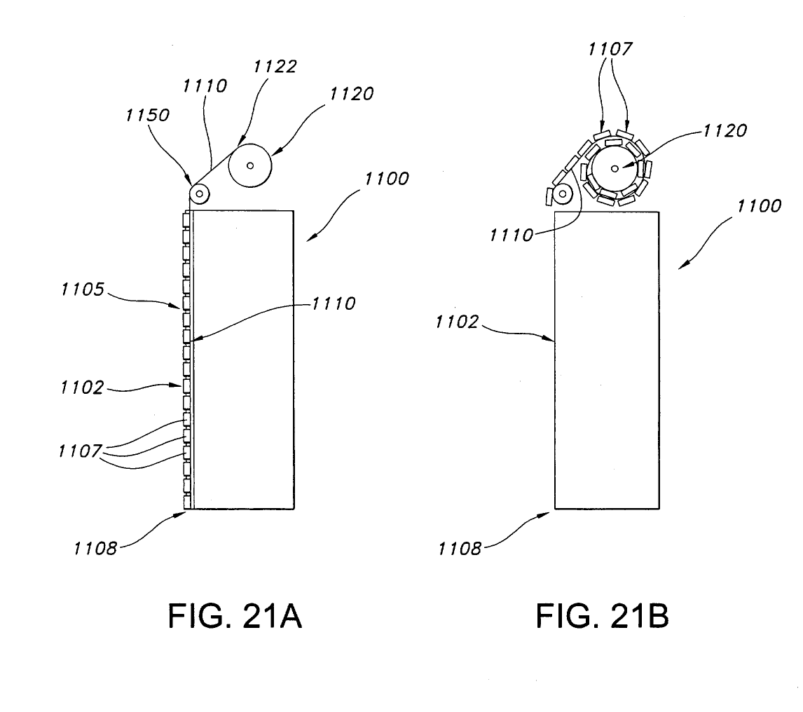

FIGS. 21A, 21B and 22 depict an embodiment of the dispenser 1100 in which the door 1105 is moved between an open and a closed position by a spring assembly 1120 and a drive assembly 1150. Generally speaking, in this embodiment of the invention, the various slats 1107 and flexible elongate members 1110 (e.g., flexible plastic strips or timing belts) are preferably configured and dimensioned as discussed above in regard to FIGS. 18-20B. In this embodiment of the invention, one or more (and preferably two) flexible elongate members 1110, 1112 are attached relative a drive assembly 1150 that is configured to move the door 1105 between a closed and an open position. The dispenser 1100 also includes a spring assembly 1120 that is configured to pull the door 1105 toward the spring assembly 1120 and wrap the door 1105 around a portion of the spring assembly 1120 as the door 1105 is moved into an open position. Similarly, the spring assembly 1120 is configured to retain at least a portion of the door 1105 on a portion of the spring assembly 1120 until the door 1105 is moved into a closed position by the drive assembly 1150. In one embodiment of the invention, the drive assembly 1150 is disposed between the spring assembly 1120 and the door 1105 when the door 1105 is in a closed position.

In one embodiment of the invention, the drive assembly 1150 is configured to move the door 1105 into a closed position by advancing the flexible elongate members 1110, 1112 toward the dispenser's front bottom edge 1108. Similarly, the drive assembly 1150 is configured to move the door 1105 into an open position by advancing the flexible elongate members 1110, 1112 away from the dispenser's front bottom edge 1108.

FIG. 22 depicts a spring assembly 1120, a drive assembly 1150, and a top portion of a door 1107 according to a preferred embodiment of the invention. In this embodiment of the invention, the spring assembly 1120 comprises a first take-up pulley 1125 to which the door's first flexible elongate member 1110 is attached, and a second take-up pulley 1127 to which the door's second flexible elongate member 1112 is attached. The second take-up pulley 1127 is spaced apart from the first take-up pulley 1125. In one embodiment of the invention, the first and second take-up pulleys 1125, 1127 are spaced apart a distance that is about equal to the width of one or more of the slats 1007 that comprise the dispenser's door 1105.

The first and second take-up pulleys 1125, 1127 are preferably mounted on a common take up pulley shaft 1130 so that both take-up pulleys 1125, 1127 rotate in response to the take up pulley shaft 1130 being rotated. The take up pulley shaft 1130 is connected to a spring mechanism 1140 (such as a negator spring) which serves to bias the take up pulley shaft 1130 in a manner so that when the flexible elongate members 1110, 1112 are pulled away from the spring assembly 1120 and thereby rotate the take-up pulleys 1125, 1127 in a first direction, the spring mechanism 1140 and the take up pulley shaft 1130 exert an opposing rotational force on the take-up pulleys 1125, 1127 in a second direction. This produces tension in the flexible elongate members 1110, 1112.

Turning again to FIG. 22, the drive assembly 1150 preferably comprises a first drive pulley 1160 that engages an intermediate portion of the door's first flexible elongate member 1110, and a second drive pulley 1162 that engages an intermediate portion of the door's second flexible elongate member 1112. The second drive pulley 1162 is spaced apart from the first drive pulley 1160. In one embodiment of the invention, the first and second drive pulleys 1160, 1162 are spaced apart a distance that is about equal to the width of one or more of the slats 1007 that comprise the dispenser's door 1105. Also, the first and second drive pulleys 1160, 1162 are preferably generally aligned with the first and second take up pulleys 1125, 1127 as shown in FIG. 22.

The first and second drive pulleys 1160, 1162 are preferably mounted on a common drive shaft 1165 so that both drive pulleys 1160, 1162 rotate in response to the drive shaft 1165 being rotated. The drive shaft 1165 is connected to a drive mechanism 1155, such as a motor, so that the drive mechanism 1155 selectively rotates the drive shaft 1165 in either of two directions. As will be understood by one skilled in the art, the drive mechanism may be connected to drive the drive shaft in many different ways. However, in a preferred embodiment of the invention, the drive mechanism's drive shaft 1156 is connected to the dispenser door drive shaft 1165 using sprockets 1157 and a chain 1158 as shown in FIG. 22.

As may be understood from FIGS. 21A, 21B, and 22, the door's first flexible elongate member 1110 is attached at one end to the first take up pulley 1125. The first flexible elongate member 1110 is also positioned so that the first drive pulley 1160 engages a portion of the first flexible elongate member 1110 intermediate the first take up pulley 1125 and the door's top slat 1107 when the door 1105 is in a fully closed position. Similarly, the door's second flexible elongate member 1112 is attached at one end to the second take up pulley 1127. The second flexible elongate member 1112 is also positioned so that the second drive pulley 1162 engages a portion of the second flexible elongate member 1112 intermediate the second take up pulley 1127 and the door's top slat 1107 when the door 1105 is in the fully closed position.

As may also be understood from FIGS. 21A, 21B, and 22, in this embodiment of the invention, the dispenser 1100 is preferably configured so that when the drive mechanism 1155 rotates the drive shaft 1165 in a first direction, the first and second drive pulleys 1160, 1162 are also rotated in the first direction. This advances the first and second flexible elongate members (and the dispenser's door 1105) toward the spring assembly 1120. Simultaneously, the spring mechanism 1140 exerts a rotational force on the take up pulley shaft 1130 in a first direction which causes the first and second take up pulleys 1125, 1127 to rotate in the first direction. This general motion causes the door 1105 to move from a closed position (shown in FIG. 21A) in which the door 1105 is positioned adjacent the dispenser's front surface, to an open position in which the door 1105 is substantially supported by at least a portion of the spring assembly 1120. In this embodiment of the invention, when the door 1105 is in the fully open position, a portion of the door 1105 is wound around, and supported by, the first and second take up pulleys 1125, 1127.

Similarly, the dispenser 1100 is configured so that when the drive mechanism 1155 rotates the drive shaft 1165 in a second direction, the first and second drive pulleys 1160, 1162 rotate in the second direction, which advances the first and second flexible elongate members 1110 and 1112 toward the lower front edge 1108 of the dispenser 1100. This, in turn, causes the first and second take up pulleys 1125, 1127 to rotate in a second direction, which allows the door 1105 to unwind off of the take up pulleys 1125, 1127 and move into the closed position.

In a preferred embodiment of the invention, the spring assembly 1120 is configured to maintain tension in the portions of the flexible elongate members 1110, 1120 that extend between the drive pulleys 1160, 1162 and the take up pulleys 1125, 1127. This allows the door 1105 to move smoothly onto and off of the take up pulleys 1125, 1127.

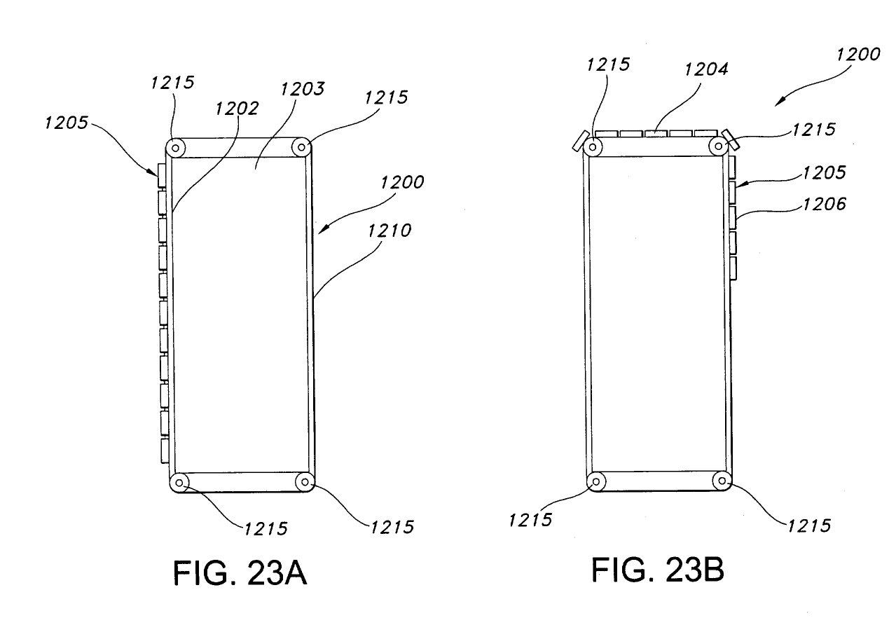

FIGS. 23A and 23B depict an additional embodiment of the dispenser 1200 in which the dispenser's door 1205 is configured to be stored in one or more substantially planar segments when the door 1205 is in the open position. For example, as shown in FIG. 23B, the door 1205 is configured to be stored so that a first portion 1204 of the door 1205 is in the form of a first linear (and substantially horizontal) segment adjacent a top portion of the dispenser 1200, and so that a second portion 1206 of the door 1205 is in the form of a second linear (and substantially vertical) segment adjacent a rear portion of the dispenser.

In this embodiment of the invention, one or more of the elongate flexible members 1210 (e.g., a belt or timing belt) that drive the door 1205 form a preferably rectangular loop that is supported by one or more pulleys 1215. The one or more elongate flexible members 1210 are attached to a drive mechanism in any manner known in the art so that the elongate flexible members 1210 (and therefore the door 1205) may be selectively moved about the loop defined by the elongate flexible members 1210. For example, the door 1205 may be moved from a closed position (shown in FIG. 23A) in which the door 1205 is adjacent a front surface of the dispenser 1200 (and thereby restricts access to an interior portion of the dispenser 1200) to an open position (shown in FIG. 23B) in which the door 1205 is configured to permit access to an interior portion of the dispenser 1200. In one embodiment of the invention, the elongate flexible members 1210 and the door 1205 are configured so that the door 1205 is adjacent an exterior surface (and preferably adjacent both an upper and a rear exterior surface of the dispenser 1200) when the door 1205 is in an open position.

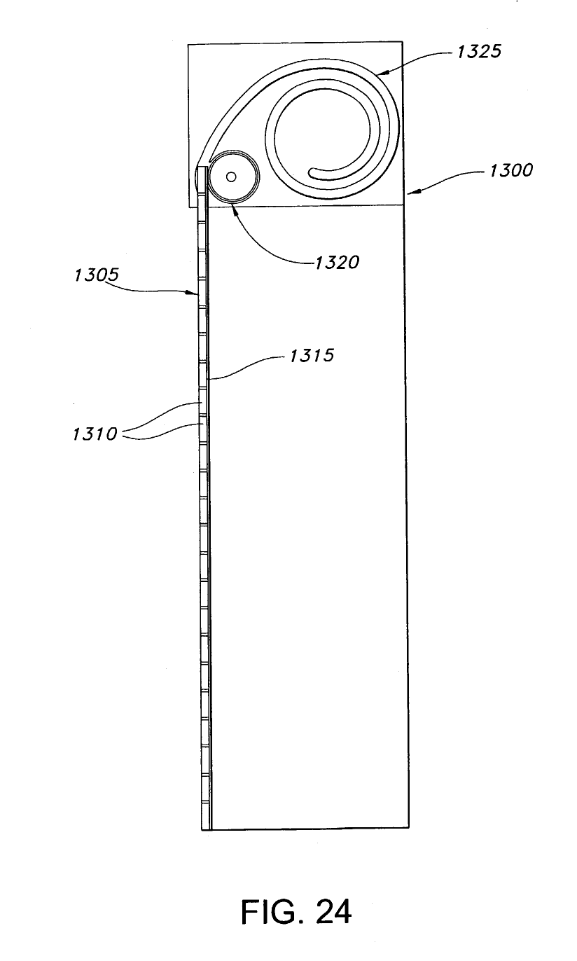

FIG. 24 depicts yet another embodiment of the dispenser 1300. In this embodiment, the dispenser 1300 includes a drive assembly 1320, that is preferably configured similarly to the drive assembly 1150 discussed above in regard to FIG. 22. The dispenser 1300 further comprises a preferably elongate recess 1325 that is configured for receiving the door 1305 as the door 1305 is moved from the closed to the open position, and for storing the door 1305 when the door 1305 is in an open position. This recess 1325 is preferably about the same width as at least one (and preferably all) of the slats 1310 that comprise the door 1305. Also, the recess 1325 is preferably formed so that the interior portion of the recess 1325 substantially conforms to the general exterior form of the door 1305 when the door 1305 is in the open position. In one embodiment of the invention, the exterior form of the door 1305 when the door 1305 is in the open position is substantially the same as the general form of the recess 1325.

In a particular embodiment of the invention, the height of the recess 1325 is substantially uniform and corresponds generally to the depth of one or more of the slats 1310 that comprise the door 1305. In one embodiment of the invention, the recess 1325 is generally in the form of a loose spiral (as shown generally in FIG. 24), but the recess 1325 may be in any other, preferably gradually curved, form.

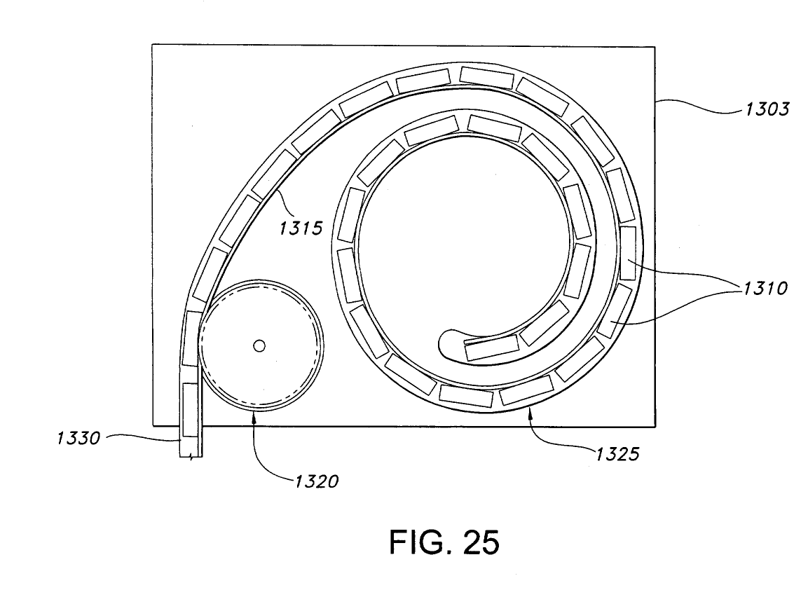

In this embodiment of the invention, the various slats 1310 that form the door 1305 are preferably linked by a substantially non-compressible elongate flexible member 1315 (such as a plastic strip, or a grooved timing belt). This helps to facilitate the movement of the door 1305 into the recess 1325 as the door 1305 is being moved into an open position (shown in FIG. 25), and also to facilitate movement of the door out of the recess 1325 as the door 1305 is being moved into a closed position (shown in FIG. 24). In one embodiment of the invention, the door 1305 is structurally configured like the door 1005 discussed above in regard to FIG. 19.

Conclusion

Many modifications and other embodiments of the invention will come to mind to one skilled in the art to which this invention pertains having the benefit of the teachings presented in the foregoing descriptions and the associated drawings. For example, as will be understood by one skilled in the art, the dispenser may be used, in either a modified or unmodified form, in contexts other than a hospital environment. For example, the dispenser may be used to dispense towels in a health club, or towels or linens in a hotel environment. Similarly, the dispenser may be used, either in a modified or unmodified form, to dispense items other than fabric items (e.g., non-fabric items, medical supplies, tools, and office supplies).

Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What I claim is:

1. A dispenser comprising:
a housing defining an interior portion;
a door for selectively restricting access to said interior portion, said door being configured so that, when said door moves from a closed to an open position, at least a first portion of said door moves within a plane defined by said first portion to create an opening through which a user may access said interior portion of said housing; and
a control system for regulating access to said interior portion.

2. The dispenser of claim 1, wherein said control system is configured for regulating access to said interior portion by controlling the movement of said door.

3. The dispenser of claim 1, wherein said control system comprises a central processing unit that is configured to use identification information received from a user to determine whether to allow said user to access said interior portion.

4. The dispenser of claim 1, wherein said door is configured so that, when said door moves from said closed to said open position, a leading end of said door moves away from a portion of said housing to create said opening.

5. The dispenser of claim 1, wherein at least a portion of said door is flexible.

6. The dispenser of claim 1, wherein said door is configured so that, when said door moves from an open to a closed position, said first portion of said door moves within said plane defined by said first portion.

7. The dispenser of claim 6, wherein said door is configured so that, when said door moves from an open to a closed position, said leading end of said door moves toward said portion of said housing to close said opening, and thereby restricts access to said interior portion of said housing.

8. The dispenser of claim 1, wherein said door is a tambour door.

9. The dispenser of claim 1, further comprising a rotatable door support, and wherein said door is mounted adjacent said rotatable door support so that, when said rotatable door support is rotated in a first direction, a portion of said door wraps around said rotatable door support.

10. The dispenser of claim 9, further comprising a spring member for maintaining said door in place on said rotatable door support.

11. The dispenser of claim 9, wherein said door is mounted so that, when said rotatable door support is rotated in said first direction, said door moves from a closed position to an open position in which a user may access said interior portion of said housing.

12. The dispenser of claim 9, wherein said door is mounted so that, when said rotatable door support is rotated in a second direction, a portion of said door moves away from said rotatable door support.

13. The dispenser of claim 12, wherein said door is mounted so that, when said rotatable door support is rotated in said second direction, said door moves from an open position to a closed position and thereby restricts access to said interior portion of said housing.

14. The dispenser of claim 1, further comprising at least one track for guiding the movement of said door, and wherein said door is configured to slide adjacent said at least one track.

15. The dispenser of claim 14, wherein:
said at least one track comprises both: (1) a “door closed” portion for supporting said door when said door is in a closed position in which said door restricts access to said interior portion of said housing; and (2) a “door open” portion for supporting said door when said door is in an open position in which said door does not restrict access to said interior portion of said housing.

16. The dispenser of claim 15, wherein said at least one track and said door are configured so that: (1) when said door is in said open position, a portion of said door is immediately adjacent said “door open” portion of said track; and (2) when said door is in said closed position, a portion of said door is immediately adjacent said “door closed” portion of said track.

17. The dispenser of claim 1, wherein said door is configured so that, when said door is in said open position, said door is positioned so that a first portion of said door is in the form of a first substantially planar segment, and so that a second portion of said door is in the form of a second substantially planar segment.

18. The dispenser of claim 17, wherein said first segment and said second segment form an angle of about ninety degrees.

19. The dispenser of said claim 17, wherein said first segment is disposed adjacent a top portion of said dispenser, and said second segment is disposed adjacent a rear portion of said dispenser.

20. The dispenser of claim 19, wherein said first and second segments are disposed adjacent exterior surfaces of said dispenser.

21. The dispenser of claim 1, wherein said housing defines an elongate recess that is configured for receiving said door as said door is moved from said closed to said open position, and for storing said door when said door is in said open position.

22. The dispenser of claim 21, wherein said elongate recess is configured to receive and store at least half of said door within said recess.

23. The dispenser of claim 21, wherein said recess is about the same width as at least a portion of said door.

24. The dispenser of claim 21, wherein a height of said recess is substantially uniform and corresponds generally to a depth of at least a portion of said door.

25. The dispenser of claim 21, wherein at least a portion of said recess is gradually curved.

26. The dispenser of claim 21, wherein said recess is generally in the form of a loose spiral.

27. The dispenser of claim 21, wherein said recess is formed so that an interior portion of said recess substantially conforms to a general exterior form of said door when said door is in said open position.

28. The dispenser of claim 21, wherein said door comprises a plurality of slats, said plurality of slats being linked together by at least one substantially non-compressible flexible member.

29. The dispenser of claim 1, further comprising a drive mechanism for moving said door between said open position and said closed position.

30. The dispenser of claim 29, further comprising an access system for verifying that a user is permitted to access said interior portion of said housing, and wherein said drive mechanism is configured to move said door from said closed position to said open position in response to said access system determining that a particular user is permitted to access said interior portion of said housing.

31. The dispenser of claim 30, wherein said access system comprises an access card reader.

32. The dispenser of claim 30, wherein said access system is configured for verifying an access code input by a user.

34. The dispenser of claim 29, wherein said dispenser is configured so that said drive mechanism automatically moves said door from said open position to said closed position in response to a pre-determined event.

35. The dispenser of claim 34, wherein said predetermined event is the passage of a pre-determined period of time after the door is moved into said open position.

36. The dispenser of claim 34, wherein said pre-determined event is the activation, by a user, of a “close-door” activation device.

37. The dispenser of claim 34, wherein said pre-determined event is that a sensor has failed to detect the presence of a user for a pre-determined period of time.

38. The dispenser of claim 1, further comprising a locking device for selectively preventing a user from opening said door when said locking device is activated.

39. The dispenser of claim 38, further comprising an access system for verifying that a user is permitted to access said interior portion of said housing, and wherein said locking device is configured to assume an “unlocked” configuration in response to said access system determining that a particular user is permitted to access said interior portion of said housing.

40. A method of selectively distributing items, said method comprising the steps of:
(A) providing a housing defining an interior portion;
(B) providing a flexible door that is configured for selectively restricting access to said interior portion;
(C) receiving a request from a user for permission to access said interior portion;
(D) determining whether said user has permission to access said interior portion;
(E) in response to determining that said user has permission to access said interior portion, moving said flexible door to allow said user to access one or more items within said interior portion; and
(F) after said Step (E) of moving said flexible door to allow said user to access one or more items within said interior portion, automatically moving said door from said open position to said closed position in response to a pre-determined event.

41. The method of claim 40, wherein said pre-determined event is that a pre-determined period of time has elapsed since a user was permitted to access said interior portion of said housing.

42. The method of claim 40, wherein said pre-determined event is that a user has activated a “close-door” activation device.

43. The method of claim 40, wherein said pre-determined event is that a sensor has failed to detect the presence of a user.

44. The method of claim 40, wherein said flexible door is a roll-up door.

45. The method of claim 40, wherein said flexible door is mounted on tracks.

47. A method of selectively distributing items to a user, said method comprising the steps of:
(A) providing a housing defining an interior portion;
(B) maintaining an inventory of one or more items within said interior portion;
(C) providing a flexible, roll-up door that is configured for selectively restricting access to said items;
(D) receiving a request from a user for permission to access one or more of said items;
(E) determining whether said user has permission to access said items; and
(F) in response to determining that said user has permission to access said items, automatically moving said flexible, roll-up door to allow said user to access one or more items within said interior portion.

48. The method of claim 47, wherein said items comprise one or more hospital linens.

49. A method of selectively distributing hospital linens, said method comprising the steps of:
(A) providing a secure, automated dispenser in a hospital;
(B) placing one or more hospital linens within said automated dispenser;
(C) using said automated dispenser to perform the steps of:
(1) receiving a request from a user for permission to access one or more of said hospital linens;
(2) determining whether said user has permission to access said hospital linens; and
(3) in response to determining that said user has permission to access said hospital linens, automatically moving a dispenser door to allow said user to access one or more hospital linens within said interior portion.

50. The method of claim 49, wherein said dispenser door is a roll-up door.

51. The method of claim 49, wherein said dispenser door is a tambour door.

52. A dispenser comprising:
a housing defining a recess;
a door that is configured for selectively restricting access to items stored within said recess; and
a control panel disposed so that at least a portion of said control panel is adjacent a front surface of said door.

53. The dispenser of claim 52, wherein said control panel is disposed so that said control panel overlaps said front surface of said door.

54. The dispenser of claim 52, wherein at least a third of said control panel overlaps said front surface of said door.

55. The dispenser of claim 52, wherein at least half of said control panel overlaps said front surface of said door.

56. The dispenser of claim 52, wherein said control panel is configured to rotate between: (A) a first position, in which said control panel overlaps a front surface of said door; and (B) a second position, in which said control panel does not substantially overlap a front surface of the door.

57. The dispenser of claim 52, wherein said control panel is mounted to partially obstruct a front opening of said recess.

58. The dispenser of claim 52, wherein said door is a roll-up door.
